(19) United States
(12) Patent Application Publication
(10) Pub. No.: US 2009/0112652 A1
(43) Pub. Date: Apr. 30, 2009

(54) PROJECT PUBLISHING SYSTEM AND METHOD

(76) Inventors: Mark Kelsey, Greenwood, IN (US); Bobby Samuel, Bloomington, IN (US); Marc Powell, Bloomington, IN (US); David Bruce McCauley, Greenwood, IN (US); Gary Hillard, Indianapolis, IN (US); Keith R. Williamson, Bloomington, IN (US); Sandra Powell, Bloomington, IN (US); Nathan Paul Williamson, Linton, IN (US); Mike Murnan, Bloomington, IN (US)

Correspondence Address: Intellevate, P.O. Box 52050, Minneapolis, MN, 55402, US

(21) Appl. No.: 11/932,627

(22) Filed: Oct. 31, 2007

(51) Int. Cl. G06F 17/00

(52) U.S. Cl. 705/7

(57) ABSTRACT

A method and system of project publishing are disclosed. In one embodiment, a method includes generating self publishing services associated with a project, generating automated publishing services associated with the project, generating advanced publishing optimization services associated with the project, and generating post publishing tracking services associated with the project. The project may include a book, a periodical, an audio book, advertising copy, a screenplay, a newsletter, music, a video file, and/or an audio file. The generating self publishing services associated with a project may include selecting a media type and a size of publication of the project, downloading templates of current content of the project, receiving uploaded completed manuscripts of the project, creating artwork associated with the project, generating targeted offers of upgraded services, setting a pricing of the project and/or a retail discount amount of the project, and/or selecting optional distribution services of the project.

### FIELD OF TECHNOLOGY

This disclosure relates generally to the technical field of communications and, in one example embodiment, to a method and system of project publishing.

### BACKGROUND

Works of authorship may bring books, films, and other creative projects to the public. Upon completion of a draft form of the work, an author may want to publish, market, and distribute the work.

The author, however, may not have the resources on hand to do so. For example, the author may not have publishing tools or time necessary to self-publish the work. The author may not have the capabilities or financial resources to locate and retain a publishing company to publish the work. The author may be unable to market and distribute the work for similar reasons.

Upon selling or offering the work for sale, the author may not be positioned to manage orders, sales financials, royalties, and the like.

### SUMMARY

A method and system of project publishing are disclosed. In one aspect, a method includes generating self publishing services associated with a project (e.g., may include a book, a periodical, an audio book, advertising copy, a screenplay, a newsletter, music, a video file, and/or an audio file, etc.), generating automated publishing services associated with the project, generating advanced publishing optimization services associated with the project, and generating post publishing tracking services associated with the project.

The generating self publishing services associated with a project may include selecting a media type and a size of publication of the project, downloading templates of current content of the project, receiving uploaded completed manuscripts of the project, creating an artwork associated with the project, generating targeted offers of upgraded services, setting a pricing of the project and/or a retail discount amount of the project, and/or selecting optional distribution services of the project.

The creating an artwork associated with the project may include receiving an uploaded existing artwork based on a provided template, generating the artwork via an artwork wizard having guided instruction steps, selecting a theme category of the artwork, selecting a background color of the artwork, selecting a font style, a font size, and/or a font color of a title of the project, a subtitle of the project, and/or a pen name of the project, generating a front cover of the artwork, a back cover of the artwork, and/or a spine of the artwork, receiving uploaded images associated with the artwork, and/or dragging and locating artwork elements to design a cover layout.

The generating targeted offers of upgraded services may include generating targeted offers of upgraded services at a price dependent on a profile of the project and/or a stage of the project in conjunction with generated free services. The generating automated publishing services associated with the project may include generating a virus scan of the project, automatically converting the project from a first format to a second format (e.g., may include automatically converting the first format of a source document of the project to the second format associated with a typesetting application and/or a business requirement), generating a libel analysis of the project (e.g., may include highlighting a portion of the project potentially associated with a libel, generating a summary of the libel analysis of the project, and/or generating a score associated with the libel analysis of the project), generating a presentation of the project, and/or generating automated print services.

The generating a presentation of the project may include generating a font analysis of the project, generating an analysis associated with an image resolution and/or an image size of the project, generating automated margins of the project (e.g., may include populating a manuscript of the project within printable margins), automatically attaching an image file and/or a non-image file to the project, generating an automated page numbering verification of the project and/or an automated calculation of the pages of the project, and/or generating an automated artwork template creation associated with the project (e.g., may include generating an image, metadata, media type, and/or spine sizing, etc.).

The generating automated print services associated with the project may include converting a manuscript of the project from a source type into an industry print standard type, generating automated proof printing of a portion of the project to media, including a paper type, an electronic media, a storage media, and/or a website, generating automated label printing and postage calculation associated with the materials of the project, and/or generating automated printing and consumption of bar-coded workflow documents associated with the project.

The generating automated printing and consumption of bar-coded workflow documents associated with the project may include generating bar-coded workflow documents unique to a portion of the project including a book and/or a task to be performed, triggering, by the bar-coded workflow documents, at least one workflow task, and triggering, by the workflow tasks, the generation of at least one bar-coded document.

The generating advanced publishing optimization services associated with the project may include integrating the project into a portion of a workflow system (e.g., may include integrating the project into a barcode reading technology, an optical character reader technology, an autodialing software system, an email management system, a phone system, an accounting system, a knowledge base, and/or a file and document management system), generating a workflow state system of the workflow system (e.g., may include driving proper events, sequences, decisions, and/or parallel activities to a destination, including automated comments and/or automated notes), load balancing the project within the workflow system and prioritizing work logic, and automatically submitting (e.g., to a publisher, a printer, a distributor, a retailer, a search engine, and/or a registration service), in industry standard format, the project and/or metadata associated with the project.

The generating advanced publishing optimization services associated with the project may also include automatically maintaining an artwork spine size associated with galley changes to the project, automatically reviewing material associated with the issues of the project and/or revenue opportunities associated with the project, extracting metadata associated with the project, validating data of the project and content consistency of the project between an artwork, a galley, accounting records, financial records, and/or a work flow system, identifying and reporting a project related issue, and/or generating at least one recommendation to resolve the project related issue.

The issues and the revenue opportunities associated with the project may include a picture, an image, an image size, an image resolution, and/or a file type. The generating post publishing tracking services associated with the project may include generating a price related to the project, determining marketing preferences associated with the project, generating customized author pages associated with the project, generating orders associated with the project, managing royalties associated with the project, managing sales activities associated with the project, tracking a status associated with the project, generating an alert and/or a notification associated with the project, generating at least one website to promote the project, and/or generating a communication associated with the project.

In another aspect, a system includes a self publishing module to generate self publishing services associated with a project (e.g., may include a book, a periodical, an audio book, advertising copy, a screenplay, a newsletter, music, a video file, and/or an audio file), an automated publishing module to generate automated publishing services associated with the project, an advanced publishing optimization module to generate advanced publishing optimization services associated with the project, and a post publishing tracking module to generate post publishing tracking services associated with the project.

The self publishing module may include a publication module to select a media type and a size of publication of the project, to download templates of current content of the project, and to receive uploaded completed manuscripts of the project, a create artwork module to create an artwork associated with the project, an offer module to generate targeted offers of upgraded services, a pricing module to set a pricing of the project and/or a retail discount amount of the project, and/or a distribution module to select optional distribution services of the project.

The create artwork module may include an artwork services module to receive an uploaded existing artwork based on a provided template, generate an artwork via a artwork wizard having guided instruction steps, select a theme category of the artwork, select a background color of the artwork, select a font style, a font size, and/or a font color of a title of the project, a subtitle of the project, and/or a pen name of the project, generate a front cover of the artwork, a back cover of the artwork, and/or a spine of the artwork, receive uploaded images associated with the artwork, and/or permit dragging and locating artwork elements to design a cover layout. The offer module may include an upgraded services module to generate target offers of upgraded services at a price dependent on a profile of the project and/or a stage of the project in conjunction with generated free services.

The automated publishing module may include a scan module to generate a virus scan of the project, a format conversion module to automatically convert the project from a first format (e.g., may be of a source document) to a second format (e.g., may be associated with a typesetting application and/or a business requirement), a libel analysis module to generate a libel analysis of the project, a presentation module to generate a presentation of the project, and/or an automated print module to generate automated print services. The libel analysis module may include a libel report module to highlight a portion of the project potentially associated with a libel, generate a summary of the libel analysis of the project, and generate a score associated with the libel analysis of the project.

The presentation module may include a font module to generate a font analysis of the project, an analysis module to generate an analysis associated with an image resolution and/or an image size of the project, a margin module to generate automated margins of the project, an attachment module to automatically attach an image file and/or a non-image file to the project, a page module to generate an automated page numbering verification of the project and/or an automated calculation of the pages of the project, and/or an artwork template creation module to generate an automated artwork template creation (e.g., may include an image, metadata, media type, and/or spine sizing) associated with the project.

The margin module may include a population module to populate a manuscript of the project within printable margins. The automated print module may include a specialized printing module to convert a manuscript of the project from a source type into an industry print standard type, generate automated proof printing of a portion of the project to media including a paper type, an electronic media, a storage media, and/or a website, generate automated label printing and postage calculation associated with materials of the project, and generate automated printing and consumption of bar-coded workflow documents associated with the project.

The generating automated printing and consumption of bar-coded workflow documents associated with the project may generate bar-coded workflow documents unique to a portion of the project including a book and/or a task to be performed, trigger, by at least one bar-coded workflow document, workflow tasks, and trigger, by at least one workflow task, the generation of a bar-coded document.

The advanced publishing optimization module associated with the project may include an integration module to integrate the project into a portion of a workflow system, a workflow state system module to generate a workflow state system of the workflow system, a load balance module to load balance the project within the workflow system and to prioritize work logic, a submission module to automatically submit (e.g., to a publisher, a printer, a distributor, a retailer, a search engine, and/or a registration service), in industry standard format, the project and/or metadata associated with the project.

The advanced publishing optimization module associated with the project may also include an artwork spine module to automatically maintain an artwork spine size associated with galley changes to the project, an automatic review module to automatically review material associated with issues of the project and/or revenue opportunities associated with the project, an extraction module to extract metadata associated with the project, a validation module to validate data of the project and content consistency of the project between an artwork, a galley, accounting records, financial records, and/or a work flow system, an issue module to identify a project related issue and report the project related issue, and/or a resolution module to generate at least one recommendation to resolve the project related issue.

The integration module may include a system integration module to integrate the project into a barcode reading technology, an optical character reader technology, an autodialing software system, an email management system, a phone system, an accounting system, a knowledge base, and/or a file and document management system. The workflow state system module may further operate to drive proper events, sequences, decisions, and/or parallel activities to at least one destination including automated comments and automated notes. The issues and the revenue opportunities associated with the project may include a picture, an image, an image size, an image resolution, and/or a file type.

The post publishing tracking module associated with the project may include a post publishing price module to generate a price related to the project, a marketing preferences module to determine marketing preferences associated with the project, an author page module to generate customized author pages associated with the project, an order module to generate orders associated with the project, a royalties module to manage royalties associated with the project, a sales module to manage sales activities associated with the project, a tracking module to track a status associated with the project, an alert module to generate an alert and/or a notification associated with the project, a website module to generate at least one website to promote the project; and/or a communication module to generate a communication associated with the project.

In yet another aspect, a publishing environment includes a first instruction set to enable the publishing environment, to include a project database having projects, and to generate a virus scan of a project, a second instruction set integrated with the first instruction set to automatically convert the project from a first format to a second format, a third instruction set integrated with the first instruction set and the second instruction set to generate a libel analysis of the project, a fourth instruction set integrated with the first instruction set, the second instruction set, and the third instruction set to generate a presentation of the project, and a fifth instruction set integrated with the first instruction set, the second instruction set, the third instruction set, and the fourth instruction set to generate automated print services associated with the project.

The publishing environment may also include a sixth instruction set to automatically convert the first format of a source document of the project to the second format associated with a typesetting application and/or a business requirement, to highlight a portion of the project potentially associated with a libel, to generate a summary of the libel analysis of the project, and to generate a score associated with the libel analysis of the project.

The publishing environment may further include a seventh instruction set to generate a font analysis of the project, an analysis associated with an image resolution and/or an image size of the project, automated margins of the project, an attachment of an image file and/or a non-image file to the project, an automated page count of the project and/or an automated calculation of the pages of the project, an automated artwork template creation (e.g., may include an image, metadata, media type, and/or spine sizing) associated with the project, and/or automated print services associated with the project.

The automated print services may include converting at least one manuscript of the project from a source type into an industry print standard type, generating automated proof printing of a portion of the project to media, including a paper type, an electronic media, a storage media, and/or a website, generating automated label printing and postage calculation associated with materials of the project, and/or generating automated printing and consumption of bar-coded workflow documents associated with the project.

The generating automated printing and consumption of bar-coded workflow documents associated with the project may include generating bar-coded workflow documents unique to a portion of the project including a book and/or a task to be performed, triggering, by the bar-coded workflow documents, workflow tasks, and/or triggering, by workflow tasks, the generation of bar-coded document.

The methods, system, and apparatuses disclosed herein may be implemented in any means for achieving various aspects, and may be executed in a form of machine-readable medium embodying a set of instruction that, when executed by a machine, causes the machine to perform any of the operation disclosed herein. Other features will be apparent from the accompanying drawing and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a publishing environment enabling publishing services associated with unpublished projects through a network, according to one embodiment.

FIG. 2 is an exploded view of the additional module(s) associated with the self publishing module of FIG. 1, according to one embodiment.

FIG. 3 is an exploded view of the additional module(s) associated with the automated publishing module of FIG. 1, according to one embodiment.

FIG. 4 is an exploded view of the additional module(s) associated with the advanced publishing optimization of FIG. 1, according to one embodiment.

FIG. 5 is an exploded view of the additional module(s) associated with the post publishing tracking module of FIG. 1, according to one embodiment.

FIG. 6 is a block diagram illustrating generation of automated publishing services associated with the projects, according to one embodiment.

FIG. 7 is a user interface view displaying an author control panel of a user profile associated with the project, according to one embodiment.

FIG. 8 is a user interface view displaying help view associated with Frequently Asked Question(s) (FAQ) directory, according to one embodiment.

FIG. 9A is a user interface view displaying project information associated with the user profile, according to one embodiment.

FIG. 9B is a user interface view displaying book size associated with the project, according to one embodiment.

FIG. 10A is a user interface view of receiving an uploaded completed manuscript of the project, according to one embodiment.

FIG. 10B is a user interface view of formatting the project in the publishing environment, according to one embodiment.

FIG. 11 is a user interface view displaying a preview of the project in the publishing environment, according to one embodiment.

FIG. 12A is a user interface view enabling the user to create an artwork associated with the project in the publishing environment, according to one embodiment.

FIG. 12B is a user interface view enabling the user to create spine for the artwork associated with the project in a publishing environment, according to one embodiment.

FIG. 13 is a user interface view illustrating scanning, bar-coding and tracking of projects in the publishing environment, according to one embodiment.

FIG. 14 is a display view illustrating a libel analysis view associated with the project in the publishing environment, according to one embodiment.

FIG. 15 is a user interface view displaying a libel analysis associated with the project, according to one embodiment.

FIG. 16 is a display view displaying issue identification report along with a resolution view, according to one embodiment.

FIG. 17 is a display view displaying data associated with quality of a document in final quality control view, according to one embodiment.

FIG. 18A is a user interface view of tracking a function associated with the project in the publishing environment, according to one embodiment.

FIG. 18B is a user interface view illustrating processing status associated with the project in the publishing environment, according to one embodiment.

FIG. 19 is a display view illustrating the post publishing tracking view associated with the project in the publishing environment, according to one embodiment.

FIG. 20 is a diagrammatic system view of a data processing system in which any of the embodiments disclosed herein may be performed, according to one embodiment.

FIG. 21 is a table view displaying various publishing services associated with the project, according to one embodiment.

FIG. 22 is a process flow of generating publishing services associated with a project, according to one embodiment.

Other features of the present embodiments will be apparent from the accompanying drawings and from the detailed description that follows.

### DETAILED DESCRIPTION

A method and system of project publishing are disclosed. In the following description, for the purposes of explanation, numerous specific details are set forth in order to provide a thorough understanding of the various embodiments. It will be evident, however to one skilled in the art that the various embodiments may be practiced without these specific details.

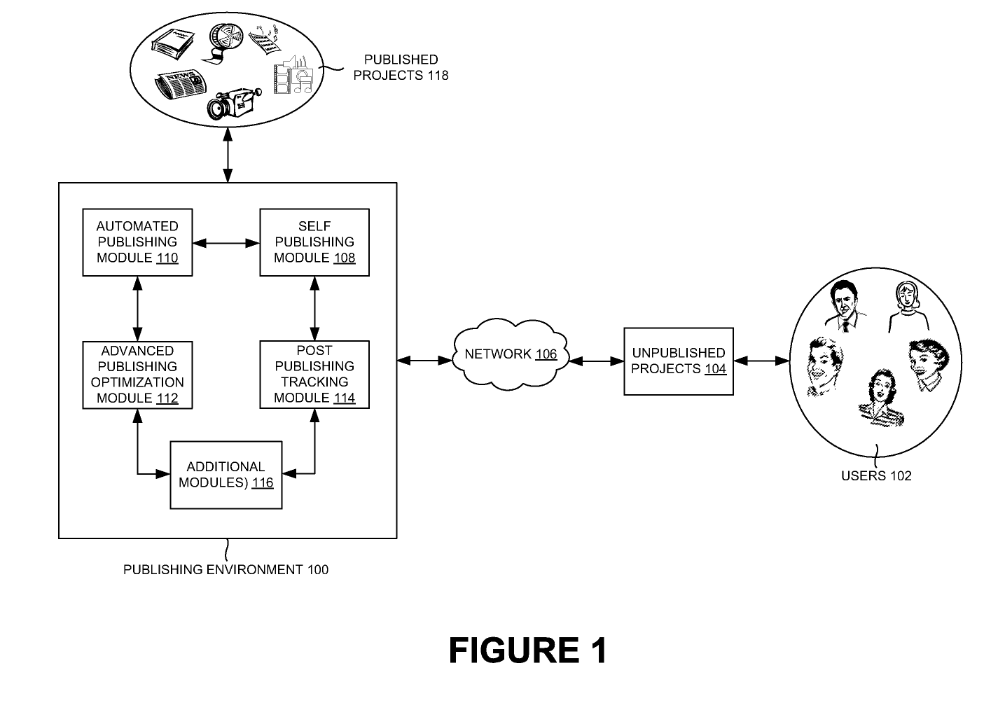

In one embodiment, a method includes generating self publishing services (e.g., using the self publishing module 108 of FIG. 1) associated with a project (e.g., of the unpublished projects 104 of FIG. 1), generating automated publishing services (e.g., using the automated publishing module 110 of FIG. 1) associated with the project 104, generating advanced publishing optimization services (e.g., using the advanced publishing optimization module 112 of FIG. 1) associated with the project 104, and generating post publishing tracking services (e.g., using the post publishing tracking module 114 of FIG. 1) associated with the project 104.

In another embodiment, a system includes a self publishing module (e.g., the self publishing module 108 of FIG. 1) to generate self publishing services associated with a project 104, an automated publishing module (e.g., the automated publishing module 110 of FIG. 1) to generate automated publishing services associated with the project 104, an advanced publishing optimization module (e.g., the advanced publishing optimization module 112 of FIG. 1) to generate advanced publishing optimization services associated with the project 104, and a post publishing tracking module (e.g., the post publishing tracking module 114 of FIG. 1) to generate post publishing tracking services associated with the project 104.

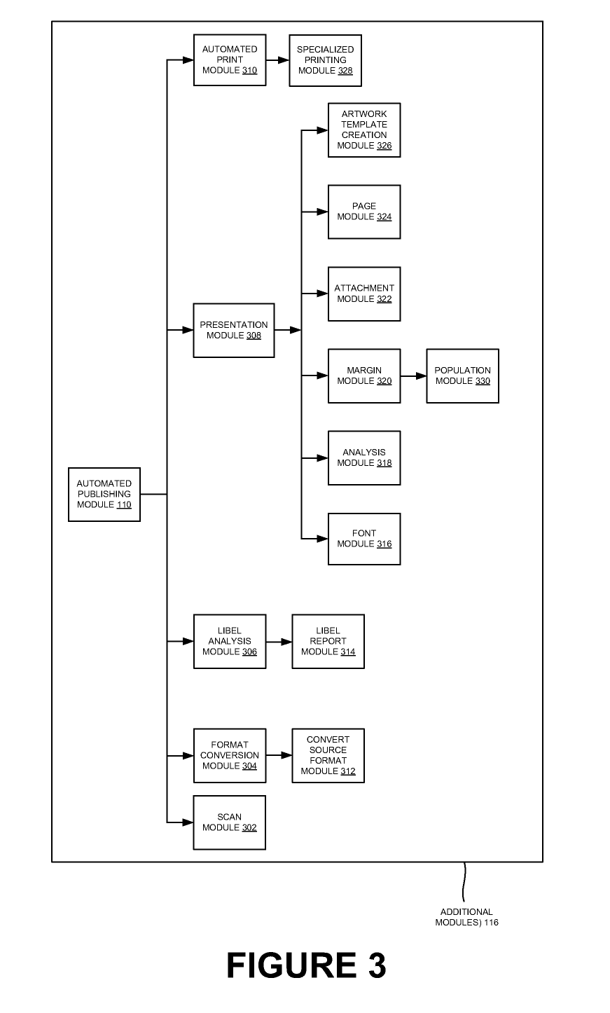

In yet another embodiment, a publishing environment (e.g., the publishing environment 100 of FIG. 1) includes a first instruction set to enable the publishing environment 100, to include a project database having projects (e.g., the unpublished projects 104 of FIG. 1), and to generate a virus scan (e.g., using the scan module 302 of FIG. 3) of a project (e.g., of the unpublished projects 104 of FIG. 1), and a second instruction set integrated with the first instruction set to automatically convert the project 104 from a first format to a second format (e.g., using the format conversion module 304 of FIG. 3).

The publishing environment 100 also includes a third instruction set integrated with the first instruction set and the second instruction set to generate a libel analysis (e.g., using the libel analysis module 306 of FIG. 3) of the project 104, a fourth instruction set integrated with the first instruction set, the second instruction set, and the third instruction set to generate a presentation (e.g., using the presentation module 308 of FIG. 3) of the project 104, and a fifth instruction set integrated with the first instruction set, the second instruction set, the third instruction set, and the fourth instruction set to generate automated print services (e.g., using the automated print module 310 of FIG. 3) associated with the project 104.

FIG. 1 is a system view of a publishing environment 100 enabling publishing services associated with unpublished projects 104 through a network 106, according to one embodiment. Particularly, FIG. 1 illustrates the publishing environment 100, users 102, unpublished projects 104, the network 106, a self publishing module 108, an automated publishing module 110, an advanced publishing optimization module 112, a post publishing tracking module 114, additional module(s) 116 and published projects 118, according to one embodiment.

The publishing environment 100 may enable generation of the publishing services associated with the unpublished projects 104 such that an online community of users 102 (e.g., authors, editors) associated with user profiles may publish their unpublished projects 104 through a publishing media (e.g., Internet). The users 102 may be members of the publishing environment 100, associated with the unpublished projects 104 and willing to publish the unpublished projects 104 through the publishing environment 100. In one example embodiment, each user 102 (e.g., author, writer, editor and/or coeditor) may be associated with one or more unpublished projects 104. The editor and/or co-editor 102 may generate published projects 118 by publishing the unpublished projects 104 through the network 106 (e.g., Internet).

The unpublished projects 104 may be books, periodicals, audio books, advertising copy, screenplays, newsletters, music, video, and/or music sound files that are completed and need to be published (e.g., in a publishing environment 100). The network 106 may facilitate communication between the publishing environment 100 and the users 102 associated with unpublished projects 104. The self publishing module 108 may generate self publishing services associated with the unpublished projects 104. For example, the self publishing services may include selecting a media type and size of publication, downloading templates, and/or receiving back content that has been formatted and inspected to industry standards for production, distribution and retailing (e.g., a manuscript that has been automatically formatted, inspected and/or completed with content (e.g., copyright pages, galleys, pages count, margins, spine size) to make suitable for printing; physical and electronic distribution and retailing system), creating artwork (e.g. covers, jackets, jewel case art, thumbnails for electronic retailing, etc.), generating targeted offers, setting price and/or retail discount amount, and/or selecting optional distribution services associated with the unpublished projects 104.

The automated publishing module 110 may generate automated publishing services associated with the unpublished projects 104. For example, the automated publishing services may include generating a virus scan, converting the project 104 from one format to another (e.g., based on a business requirement), generating a libel analysis and a presentation, and/or generating automated print services associated with the unpublished projects 104.

The advanced publishing optimization module 112 may generate advanced publishing optimization services associated with the unpublished projects 104. For example, the advanced publishing optimization services may include submitting (e.g., to a publisher, printer, retailer, etc.), unpublished projects 104 and/or metadata associated with the projects 104 in industry standard formats, identifying and reporting a project related issue, generating a recommendation to resolve the project related issue and/or extracting metadata associated with the projects 104, etc.

The post publishing tracking module 114 may generate post-publishing tracking services associated with the unpublished projects 104. For example, the post-publishing tracking services may include pricing, marketing, orders, royalties, sales, status, alert, website to promote projects, and/or notifications associated with unpublished projects 104. The additional module(s) 112 may generate additional processes to generate an online network of users 102 (e.g., writers, editors, authors and/or coeditors, etc.) where the users 102 can publish the unpublished projects 104 (e.g., book, journal, periodical, etc.) through the network 106 to the publishing environment 100.

The published projects 118 may refer to projects that are published in the publishing environment 100 by the users 102. The published projects 118 may make information associated with the projects 118 available for public view, either on the internet and/or in other forms (e.g., newspapers, journals, periodicals etc.).

In the example embodiment illustrated in FIG. 1, the publishing environment 100 includes the self publishing module 108, the automated publishing module 110, the advanced publishing optimization module 112 and the additional module(s) 116 communicating with each other. The publishing environment 100 also communicates with the users 102 associated with the unpublished projects 104 through the network 106. In addition, the publishing environment 100 communicates with the published projects 118.

For example, self publishing services associated with a project 104 (e.g., may be a book, a periodical, an audio book, advertising copy, a screenplay, a newsletter, music, a video file, and/or an audio file) may be generated (e.g., using the self publishing module 108 of FIG. 1). Automated publishing services associated with the project 104 may be generated (e.g., using the automated publishing module 110 of FIG. 1). Advanced publishing optimization services associated with the project 104 may be generated (e.g., using the advanced publishing optimization module 112 of FIG. 1). Post publishing tracking services associated with the project 104 may be generated (e.g., using the post publishing tracking module 114 of FIG. 1).

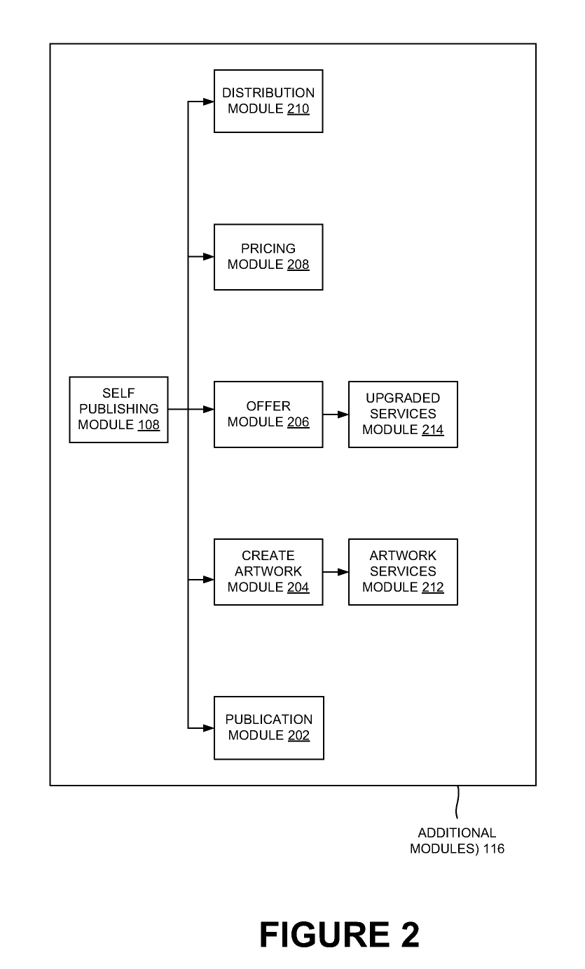

FIG. 2 is an exploded view of the additional module(s) 116 associated with self publishing module 108 of FIG. 1, according to one embodiment. Particularly, FIG. 2 illustrates the self publishing module 108, a publication module 202, a create artwork module 204, an offer module 206, a pricing module 208, a distribution module 210, an artwork services module 212 and an upgraded services module 214, according to one embodiment.

The publication module 202 may select a media type and a size of publication for the project 104. The media type may include text, an image, audio, video, etc. and the size of the publication may refer to an amount of space occupied by the project 104. The publication module 202 may also download templates of current content and receive uploaded completed manuscripts associated with the project 104. For example, the user 102 (e.g., the owner of the project 104) may submit a new project to a publishing media by downloading the templates (e.g., submission forms) available from the publishing media (e.g., Internet). In addition, the completed manuscripts (e.g., completed documents available in the website) associated with the project 104 may be received during the publishing of the project 104.

The create artwork module 204 may create an artwork associated with the project 104. For example, the artwork may include title, subtitle, author name, artwork theme, background color, images, artistic elements, etc. The offer module 206 may generate targeted offers of upgraded services (e.g., the projects 104). For example, a price forecast may be projected by the user (e.g., owner of the project 104) for marketing the project 104 based on demand of the project 104 in the current market or network.

The pricing module 208 may set a price and/or a retail discount amount associated with the project 104. For example, the user (e.g., owner) may charge the project 104 based on factors such as a quality of the project 104, category of the market sector, interest level of other users in the project 104, and/or other factors (e.g., demand, etc.). The distribution module 210 may select optional distribution services associated with the project 104. For example, the user 102 (e.g., owner of the project 104) markets the project 104 over the internet in a fully indexed and/or fully searchable electronic collection of high-quality content.

The optional distribution services may include downloading the project 104 directly from the website, and/or receiving through mail from the user 102 (e.g., owner of the project 104), etc. The artwork services module 212 may receive uploaded existing artwork for incorporation based on a provided template, generate an artwork via an artwork wizard (e.g., may include guided instruction steps for creating the artwork) and may select a theme category and a background of the artwork. In addition, the artwork services module 212 may select a font style, a font size, and/or a font color associated with a title, a subtitle, and/or a pen name (e.g., name used by the author rather than his/her true name) of the project 104.

Also, the artwork services module 212 may generate a front piece (e.g., front cover or jewel case art, etc.), a back piece and a spine of the artwork. The artwork services module 212 may receive uploaded images associated with the artwork as a subset of the completed work and/or may permit dragging and locating artistic elements to design a cover layout. For example, the artwork layout may be an arrangement of text, illustrations, graphics, title, subtitle, page numbers, font and/or typeface associated with the cover page.

The artwork services module 212 may receive an uploaded existing artwork based on a provided template, generate an artwork via an artwork wizard having guided instruction steps, select a theme category of the artwork, select a background color of the artwork, select a font style, a font size, and/or a font color of a title of the project, a subtitle of the project, and/or a pen name of the project, generate a front piece of the artwork, a back piece of the artwork, and/or a spine of the artwork, receive uploaded images associated with the artwork to be included in final art, and/or permit dragging and locating artwork elements to design a larger layout. The upgraded services module 214 may generate target offers of upgraded services at a price based on a profile of the project 104 and/or a stage of the project 104 in conjunction with generated free services.

In the example embodiment illustrated in FIG. 2, the additional modules 116 includes the self publishing module 108 which further includes the publication module 202, the create artwork module 204, the offer module 206, the pricing module 208, the distribution module 210, the artwork services module 212 and the upgraded services module 214 communicating with each other. In one embodiment, the generating self publishing services associated with the project 104 may include selecting a media type and a size of publication for the project 104 (e.g., using the publication module 202 of FIG. 2), downloading templates of current content of the project 104 (e.g., using the publication module 202 of FIG. 2), receiving uploaded completed manuscripts of the project 104 (e.g., using the publication module 202 of FIG. 2), creating artwork associated with the project 104 (e.g., using the create artwork module 204 of FIG. 2), generating targeted offers of upgraded services (e.g., using the offer module 206 of FIG. 2), setting a pricing of the project 104 and/or a retail discount amount of the project 104 (e.g., using the pricing module 208 of FIG. 2), and/or selecting optional distribution services of the project 104 (e.g., using the distribution module 210 of FIG. 2).

For example, the creating artwork associated with the project 104 may include receiving an uploaded existing artwork based on a provided template, generating an artwork via an artwork wizard having guided instruction steps, selecting a theme category of the artwork, selecting a background color of the artwork, selecting a font style, a font size, and/or a font color of a title of the project 104, a subtitle of the project 104, and/or a pen name of the project 104, generating front cover of the artwork, back cover of the artwork, and/or a spine of the artwork, receiving uploaded images associated with the artwork, and/or dragging and locating artwork elements to design an artwork layout (e.g., using the create artwork module 204 of FIG. 2). In one embodiment, the generating targeted offers of upgraded services may include generating target offers of upgraded services (e.g., using the offer module 206 of FIG. 2) at a price dependent on a profile of the project 104 and/or a stage of the project 104 in conjunction with generated free services.

FIG. 3 is an exploded view of the additional module(s) 116 associated with automated publishing module 110 of FIG. 1, according to one embodiment. Particularly, FIG. 3 illustrates the automated publishing module 110, a scan module 302, a format conversion module 304, a libel analysis module 306, a presentation module 308, an automated print module 310, a convert source format module 312, a libel report module 314, a font module 316, an analysis module 318, a margin module 320, an attachment module 322, a page module 324, an artwork template creation module 326, a specialized printing module 328 and a population module 330, according to one embodiment.

The scan module 302 may generate a virus scan of the project (e.g., the unpublished projects 104 of FIG. 1). For example, virus scan may include programs to identify, thwart and eliminate viruses and/or other malicious content associated with the project 104. The format conversion module 304 may automatically convert the project 104 from one format to another format. For example, the conversion from one format to another format may include converting a source document to a typesetting application and/or a business requirement based on type of software (e.g. PDF, HTML, XML etc) on which the project 104 has been prepared and the type of client requirement.

The libel analysis module 306 may generate a libel analysis associated with the project 104. For example, the libel analysis may include analyzing false and malicious content associated with the project 104 and highlighting the false and malicious content for further review. The presentation module 308 may generate a presentation of the project 104. For example, the presentation may be the process of disclosing the content associated with the project 104 to other users 102 through the publishing environment 100.

The automated print module 310 may generate automated print services associated with project 104. For example, the automated print services may include printing, copying, blueprinting, graphic design using offset presses, duplicators and/or high-speed copiers, etc. The convert source format module 312 may convert from a source document to a typesetting application and/or a business requirement based on the type of software (e.g. PDF, HTML, XML etc) on which the project 104 has been prepared and the type of businesses requirement of the project 104.

The libel report module 314 may highlight the libelous content (e.g., the false and/or malicious content) for review, generate a summary of the libelous content, and/or generate a score of the libelous content based on the libel analysis of the project 104. For example, the score may be a number that expresses an amount of libelous content present in the project 104. The font module 316 may generate a font analysis associated with the project 104. For example, the font analysis may include analysis of typeface style (e.g., Helvetica, Times Roman, Arial, etc) and other characteristics (e.g., bold, italic, font size and/or underlining, etc) of the text associated with the project 104.

The analysis module 318 may generate an analysis associated with image resolution and/or image size of the project 104. For example, the image resolution and/or image size may represent an amount of information stored in each image associated with the project 104. The margin module 320 may generate automated margins associated with the project 104. In one example embodiment, the content associated with the project 104 may be printed and/or copied within the margins. For example, the automated margins may refer to the margins that are present after the content associated with the project 104 has been trimmed.

The attachment module 322 may automatically attach an image file and/or a non-image file to the project 104. For example, the image file and/or non-image file may contain information needed to present a graphical image and/or metadata associated with the project 104. The page module 324 may generate an automated page numbering verification and/or an automated calculation of the pages associated with the project 104. The artwork template creation module 326 may generate an automated artwork template creation associated with the project 104. For example, the automated artwork template may include an image, metadata, media type, and/or spine sizing.

The automated artwork template creation refers to a pre-designed generic artwork page which may be used as a base to create and/or upload new unpublished projects 104. The specialized printing module 328 may convert a projects manuscript of the project 104 from a source type (e.g. PDF, HTML, XML in which the project 104 is written) into an industry print standard type (e.g., according to industry requirements and/or industry specification), generate automated proof printing of a portion of the project 104 to media (e.g., paper type, storage media, website media, etc.), generate automated label printing and postage calculation (e.g., mailing charges) associated with proof materials of the project 104, and generate automated printing and/or consumption of bar-coded workflow documents associated with the project 104.

For example, the bar-coded workflow may be a unique identifier used for automatic identification of the projects 104 in the publishing environment 100. The population module 330 may populate a manuscript (e.g., text, content, etc.) of the project 104 within industry standard printable margins.

In one embodiment, the generating automated publishing services associated with the project 104 may include generating a virus scan of the project 104 (e.g., using the scan module 302 of FIG. 3), automatically converting the project 104 from a first format to a second format (e.g., using the format conversion module 304 of FIG. 3), generating a libel analysis of the project 104 (e.g., using the libel analysis module 306 of FIG. 3), generating a presentation of the project 104 (e.g., using the presentation module 308 of FIG. 3), and/or generating automated print services (e.g., using the automated print module 310 of FIG. 3).

For example, automatically converting the project 104 from a first format to a second format may include automatically converting the first format of a source document of the project 104 to the second format associated with a typesetting application and/or a business requirement. The generating a libel analysis of the project 104 may include highlighting (e.g., using the libel analysis module 306 of FIG. 3) a portion of the project 104 potentially associated with libel, generating (e.g., using the libel analysis module 306 of FIG. 3) a summary of the libel analysis of the project 104, and/or generating a score (e.g., using the libel analysis module 306 of FIG. 3) associated with the libel analysis of the project 104 for further review. The generating a presentation of the project 104 may include generating a font analysis of the project 104 (e.g., using the font module 316 of FIG. 3) to check if fonts are permitted for use (e.g., in terms of copyright laws and industry requirements and standards (e.g., embedding)), generating an analysis (e.g., using the analysis module 318 of FIG. 3) associated with the artwork quality (e.g., an image resolution and/or an image size of the project 104), generating automated margins (e.g., using the margin module 320 of FIG. 3) of the project 104 (e.g., may include populating a manuscript of the project 104 within industrial standards printable margins), automatically attaching (e.g., using the attachment module 322 of FIG. 3) an image file and/or a non-image file to the project 104, generating (e.g., using the page module 324 of FIG. 3) an automated page numbering verification of the project 104 and/or an automated calculation of the pages of the project 104, and/or generating (e.g., using the artwork template creation module 326 of FIG. 3) an automated artwork template creation associated with the project 104 (e.g., may include generating an image, metadata, media type and/or spine sizing, etc.) and/or creating variations for related use (e.g., artwork thumbnails).

For example, the generating automated print services associated with the project 104 may include converting (e.g., using the automated print module 310 of FIG. 3) a manuscript of the project 104 from a source type into an industry print standard type, generating (e.g., using the automated print module 310 of FIG. 3) automated proof printing of a portion of the project 104 to media, including a paper type, electronic media, storage media, and/or a website media, generating (e.g., using the automated print module 310 of FIG. 3) automated label printing and postage calculation associated with materials of the project 104, and/or generating (e.g., using the automated print module 310 of FIG. 3) automated printing and consumption of bar-coded workflow documents associated with the project 104. The generating automated printing and consumption of bar-coded workflow documents associated with the project 104 may include generating bar-coded workflow documents unique to a portion of the project 104 including a book and/or a task to be performed, triggered by the bar-coded workflow documents, a workflow task, and/or triggered by the workflow tasks, the generation of a bar-coded document.

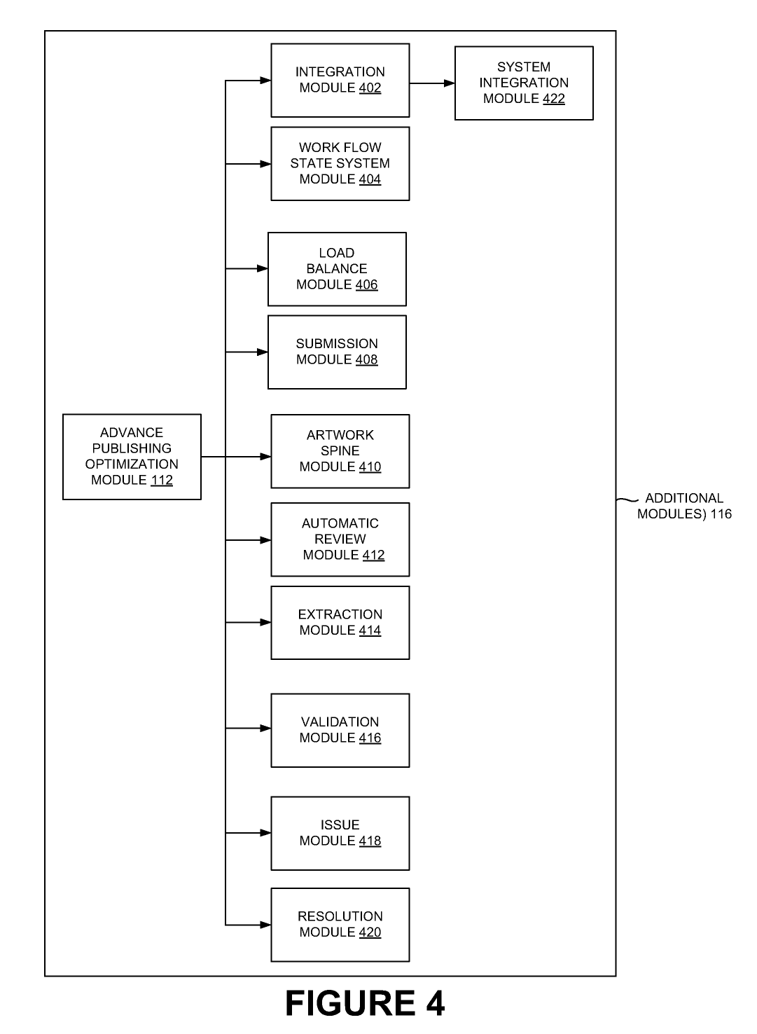

FIG. 4 is an exploded view of the additional module(s) 116 associated with advanced publishing optimization module 112 of FIG. 1, according to one embodiment. Particularly, FIG. 4 illustrates the advanced publishing optimization module 112, an integration module 402, a work flow state system module 404, a load balance module 406, a submission module 408, an artwork spine module 410, an automatic review module 412, an extraction module 414, a validation module 416, an issue module 418, a resolution module 420 and a system integration module 422, according to one embodiment.

The integration module 402 may integrate the project 104 into a portion of a workflow system. For example, the workflow system may be an operational aspect of publishing the project 104 which may include how projects 104 are structured, who performs them, etc. The workflow state system module 404 may generate a workflow state system of the workflow system. Further, the workflow state system module 404 may operate to drive proper events, sequences, decisions, and parallel activities to a destination including automatic comments and/or automated notes.

The load balance module 406 may load balance the project 104 within the workflow system and may prioritize work logic. For example, load balance may indicate the degree to which work may be evenly distributed among the available work flow system where the project 104 executes most quickly when it is perfectly load balanced. The submission module 408 my automatically submit the project 104 and/or metadata associated with the project 104 in industry standard format. For example, the project 104 may be submitted to a publisher, a printer, a distributor, a retailer, and/or a search engine based on the requirement associated with the project 104.

The artwork spine module 410 may automatically maintain an artwork spine size associated with galley page count changes to the project 104. In one example embodiment, the artwork spine may indicate the width and/or size of the project 104. In addition, the artwork spine may be increased or decreased corresponding to the addition or removal of content to the project 104, before the pages of the project 104 are numbered.

The automatic review module 412 may automatically review material associated with issues and/or revenue opportunities associated with the project 104. For example, the issues and revenue opportunities associated with the project 104 may include issues related to a picture, image, image size, image resolution and/or file type. The extraction module 414 may extract metadata associated with the project 104. For example, the metadata may be information about particular content associated with the project 104 which may describe how, when, and by whom the project 104 was received, created, accessed, and/or modified.

The validation module 416 may validate data of the project 104 and/or content consistency of the project 104 associated with the artwork (e.g., cover), the body of the work, a galley, accounting records, financial records, and/or a work flow system. In one example embodiment, the data validation and/or the consistency check may be done in order to finalize the project 104 before it has been published. The issue module 418 may identify a project related issue and report the project related issue. For example, the project related issues may arise in a picture, image, image size, image resolution, text, artwork, spine, and/or file type associated with the project 104.

The resolution module 420 may generate a recommendation to resolve the project related issue. The system integration module 422 may integrate the project 104 into a barcode reading technology, optical character reading technology, an autodialing software system, an email management system, a phone system, an accounting system, a knowledge base, and/or a file and document management system.

In the example embodiment illustrated in FIG. 4, the additional modules 116 include the advanced publishing optimization module 112 which further includes the integration module 402, the work flow state system module 404, the load balance module 406, the submission module 408, the artwork spine module 410, the automatic review module 412, the extraction module 414, the validation module 416, the issue module 418, the resolution module 420 and the system integration module 422 communicating with each other. In one embodiment, the generating advanced publishing optimization services associated with the project 104 may include integrating (e.g., using the integration module 402 of FIG. 4) the project 104 into a portion of a workflow system and integration into other system, generating (e.g., using the work flow state system module 404 of FIG. 4) a workflow state system of the workflow system, load balancing (e.g., using the load balance module 406 of FIG. 4) the project 104 within the workflow system and prioritizing work logic, automatically submitting (e.g., using the submission module 408 of FIG. 4), in industry standard format, the project 104 and/or metadata associated with the project 104, automatically maintaining (e.g., using the artwork spine module 410 of FIG. 4) relationship between the parts of the final projects (e.g., the body of the work (e.g., galley) and format (e.g., 8.5×11 inches) which impacts the artwork (e.g., cover size, spine size, etc.), automatically reviewing (e.g., using the automatic review module 412 of FIG. 4) material associated with issues of the project 104 and/or revenue opportunities (e.g., may include a picture, an image, an image size, an image resolution, and/or a file type) associated with the project 104, extracting (e.g., using the extraction module 414 of FIG. 4) metadata associated with the project 104, validating (e.g., using the validation module 416 of FIG. 4) data of the project 104 and content consistency of the project 104 between an artwork, a galley, accounting records, financial records, and/or a work flow system, identifying and reporting (e.g., using the issue module 418 of FIG. 4) a project related issue, and/or generating (e.g., using the resolution module 420 of FIG. 4) a recommendation to resolve the project related issue (e.g., the issues related to computer viruses, too many pages, too few pages, print outside margins, etc.).

For example, integrating the project 104 into a portion of a workflow system and into other systems may include integrating the project 104 into bar-code reading technology, optical character reading technology, an autodialing software system, an email management system, a phone system, an accounting system, a knowledge base, and/or a file and document management system. The generating a workflow state system of the workflow system may include driving proper events, sequences, decisions, and/or parallel activities to a destination, including automated comments and automated notes. The automatically submitting in industry standard format, the project 104 and/or metadata associated with the project 104 may include automatically submitting, in industry standard format, the project 104 and/or metadata associated with the project 104 to a publisher, a printer, a distributor, a retailer, a search engine, and/or a registration service.

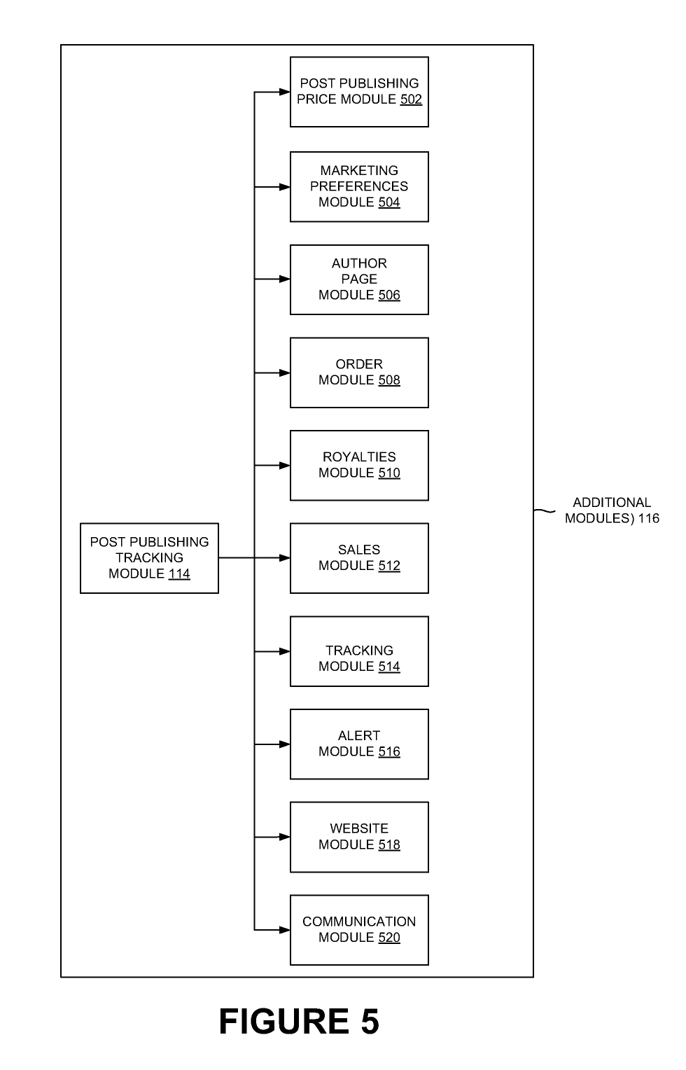

FIG. 5 is an exploded view of the additional module(s) 116 associated with post publishing tracking module 114 of FIG. 1, according to one embodiment. Particularly, FIG. 5 illustrates the post publishing tracking module 114, a post publishing price module 502, a marketing preferences module 504, an author page module 506, an order module 508, a royalties module 510, a sales module 512, a tracking module 514, an alert module 516, a website module 518 and a communication module 520, according to one embodiment.

The post publishing tracking module 114 may generate post publishing tracking services associated with project 104 (e.g., the published projects 118 of FIG. 1). For example, the post publishing tracking service may include pricing, marketing, orders, royalties, sales, status, alert and/or notifications associated with the published project 118. In one example embodiment, the published project 118 may refer to a project that is published through the publishing environment 100. In another example embodiment, the published projects 118 may refer to projects that are completed with the help of contributions or a project uploaded by an author without a need for collaborative contributions.

The post publishing price module 502 may generate a price related to the published project 118. For example, the price of the published project 118 may vary based on the interest of the users 102 in that published project 118 and/or ratings associated with the published project 118. The marketing preferences module 504 may determine marketing and distribution preferences associated with the published project 118. For example, an editor 102 (e.g., owner of the project 104) may select the market sector (e.g., university, corporate government, public library, school, etc.) in which the editor 102 may expect his/her work to be used.

The author page module 506 may generate customized author website and pages associated with the published project 118. For example, the user 102 (e.g., writer, editor, author, etc.) may customize his/her webpage based on his/her requirements, preferences and/or specifications of the published project 118. The order module 508 may generate orders associated with the published project 118. For example, generating orders may include either buying and/or selling the published project 118 which has to be processed immediately in the current market.

The royalties module 510 may manage royalties associated with the published project 118. For example, the royalties may correspond to proprietary rights associated with the published project 118. The user 102 may sell their copyright to publishing media (e.g., newspaper, website, etc.). The sales module 512 may manage sales activities associated with the published project 118. For example, sales activities may provide techniques (e.g., offers, discounts, contests, coupons, etc.) to increase profits and/or sales of the published projects 118.

The tracking module 514 may capture (e.g., store, record, identify, track, etc.) information associated with a status of the published project 118. The alert module 516 may generate alerts and/or notifications associated with the published project 118. For example, the alert module 516 may notify the users 102 about the new projects 118 that are published in the website.

The website module 518 may generate a website to promote the published project 118. In one example embodiment, the website may be dedicated to a particular topic and may be updated with the latest news, views, reviews and/or trends in order to provide publicity associated with the published project 118. The communication module 520 may generate communications associated with the published project 118. For example, the communication may include exchanging information (e.g., financial matters associated with buying, selling, viewing, etc.) of the published project 118 in the community environment 100.

The generating post publishing tracking services associated with the project 104 may include generating (e.g., using the post publishing price module 502 of FIG. 5) a price related to the project 104, determining (e.g., using the marketing preferences module 504 of FIG. 5) marketing preferences associated with the project 104, generating (e.g., using the author page module 506 of FIG. 5) customized author pages associated with the project 104, generating orders (e.g., using the order module 508 of FIG. 5) associated with the project 104, managing royalties (e.g., using the royalties module 510 of FIG. 5) associated with the project 104, managing (e.g., using the sales module 512 of FIG. 5) sales activities associated with the project 104, tracking (e.g., using the tracking module 514 of FIG. 5) a status associated with the project 104, generating (e.g., using the alert module 516 of FIG. 5) an alert and/or a notification associated with the project 104, generating (e.g., using the website module 518 of FIG. 5) a website to promote the project 104, and/or generating (e.g., using the communication module 520 of FIG. 5) communications associated with the project 104.

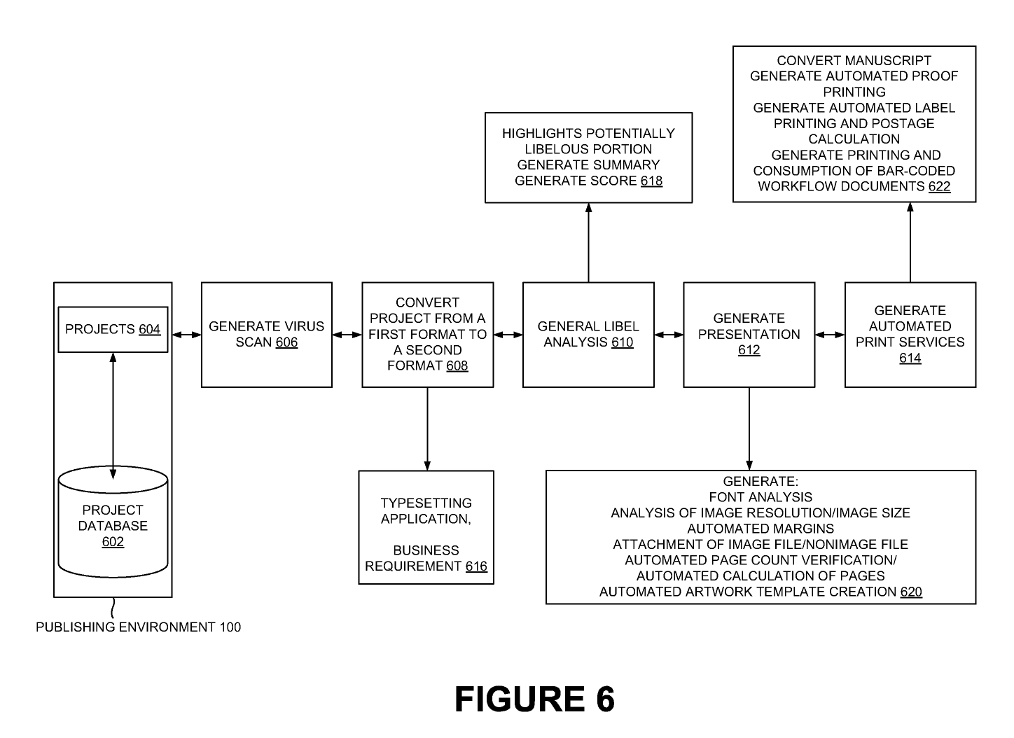

FIG. 6 is a block diagram illustrating generation of automated publishing services associated with projects 604, according to one embodiment. Particularly, FIG. 6 illustrates the publishing environment 100, a project database 602, the projects 604 and blocks 606-622, according to one embodiment.

The project database 602 may include the projects 604 (e.g., the unpublished projects and/or published projects 104 of FIG. 1) associated with automated publishing services in the publishing environment 100. The projects 604 may include books, periodicals, audio books, advertising copy, screenplays, newsletters, music, video, audio and/or music files that are completed and need to be published in the publishing environment 100. The blocks 606-620 may illustrate processes associated with the automated publishing services of the projects 604 included in the project database 602.

In the example embodiment illustrated in FIG. 6, the block 606 illustrates generating a virus scan of the projects 604. The block 608 illustrates conversion of the virus scanned projects 604 from a first format to a second format. For example, the first format may be associated with source documents of the projects 604. In one embodiment, the projects 604 may be converted from the source document to formats associated with typesetting application and/or business requirement illustrated in the block 616. Further libel analysis of the projects 604 may be generated as illustrated in the block 610. For example, the libel analysis may include highlighting a portion of the projects 604 potentially associated with libel, generating a summary of the libel analysis of the projects 604, and generating a score associated with the libel analysis of the projects 604 as illustrated in the block 618.

The automated printing services also include processes such as generating presentations of the projects 604 illustrated in the block 612 and generating automated print services associated with the projects 604 illustrated in the block 614. The block 620 illustrates processes associated with generation of presentations of the projects 604. For example, the processes include generating a font analysis of the projects 604, generating an analysis associated with an image resolution and/or an image size of the projects 604, generating automated margins of the projects 604, automatically attaching an image file and/or a non-image file to the projects 604, generating an automated page numbering verification of the project 604 and/or an automated calculation of the pages of the projects 604, and generating an automated artwork template creation associated with the projects 604.

Further, FIG. 6 illustrates processes associated with generating automated print services in the block 622 that includes converting manuscript of the projects 604 from a source type into an industry print standard type, generating automated proof printing of the project 604 to media, including a paper type, an electronic media, a storage media, and/or a website, generating automated label printing and postage calculation associated with materials of the projects 604, and generating automated printing and consumption of bar-coded workflow documents associated with the projects 604.

In one embodiment, the publishing environment 100 may include a first instruction set to enable the publishing environment 100, to include a project database 602 having projects 604, and to generate a virus scan of a project 604 and a second instruction set integrated with the first instruction set to automatically convert the project 604 from a first format to a second format. The publishing environment 100 may also include a third instruction set integrated with the first instruction set and the second instruction set to generate a libel analysis of the project 604, a fourth instruction set integrated with the first instruction set, the second instruction set, and the third instruction set to generate a presentation of the project 604, and a fifth instruction set integrated with the first instruction set, the second instruction set, the third instruction set, and the fourth instruction set to generate automated print services associated with the project 604. Further, the publishing environment 100 may include a sixth instruction set to automatically convert the first format of a source document of the project 604 to the second format associated with a typesetting application and/or a business requirement, to highlight a portion of the project 604 potentially associated with libel, to generate a summary of the libel analysis of the project 604, and to generate a score associated with the libel analysis of the project 604.

The publishing environment 100 may also include a seventh instruction set to generate a font analysis of the project 604, an analysis associated with an image resolution and/or an image size of the project 604, automated margins of the project 604, an attachment of an image file and/or a non-image file to the project 604, an automated page count of the project 604 and/or an automated calculation of the pages of the project 604, an automated artwork template creation (e.g., may include an image, metadata, and/or spine sizing, etc.) associated with the project 604, and/or automated print services associated with the project 604. For example, the automated print services may include converting a manuscript of the project 604 from a source type into an industry print standard type, generating automated proof printing of a portion of the project 604 to media, including a paper type, an electronic media, a storage media, and/or a website media, generating automated label printing and postage calculation associated with materials of the project 604, and/or generating automated printing and consumption of bar-coded workflow documents associated with the project 604.

The generating automated printing and consumption of bar-coded workflow documents associated with the project 604 may include generating bar-coded workflow documents unique to a portion of the project 604 including a book and/or a task to be performed, triggering, by the bar-coded workflow documents, workflow tasks, and triggering, by workflow tasks, the generation of bar-coded document.

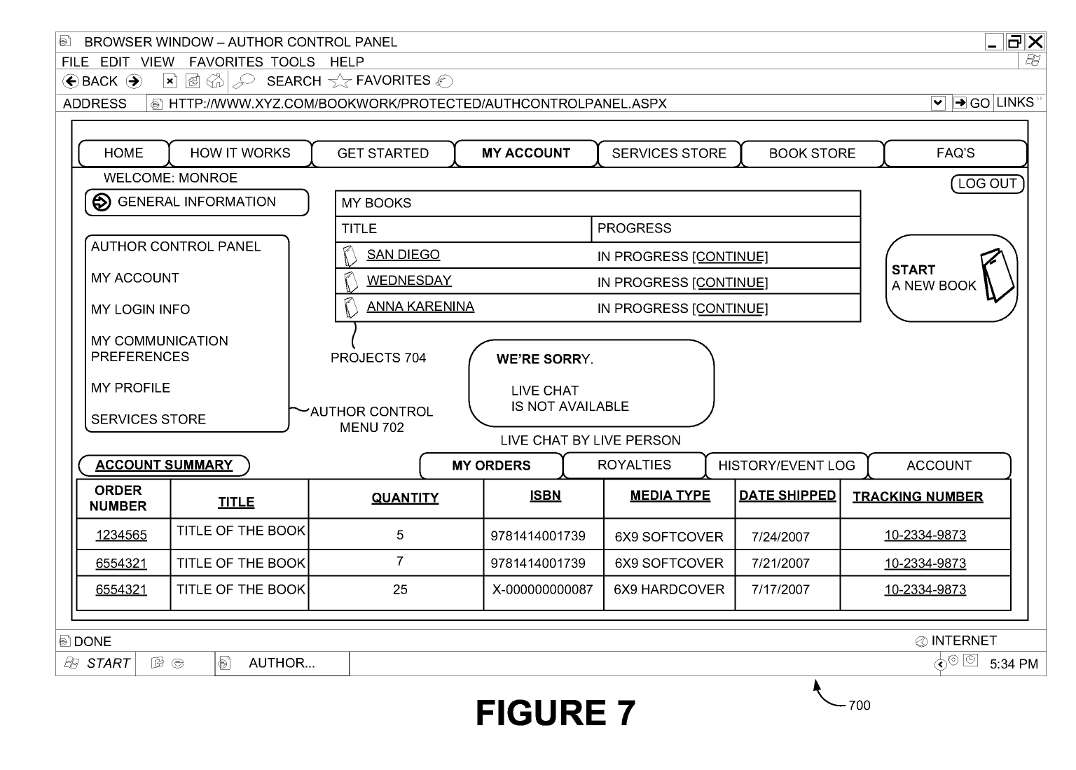

FIG. 7 is a user interface view 700 displaying an author control panel of a user profile associated with the project 104, according to one embodiment. Particularly, FIG. 7 illustrates an author control menu 702 and projects 704, according to one embodiment.

The author control menu 702 may provide general information of a user profile to the user 102 associated with the projects 704. In one embodiment, the general information provided through the author control menu 702 may include account information, login information, communication preferences, profile information, etc. The projects 704 may display manuscripts which are uploaded into the publishing environment 100 by the user 102 using self publishing services.

In the example embodiment illustrated in FIG. 7, the user interface view 700 displays the author control menu 702, the projects 704 along with the account summary associated with the projects 704. The user interface view 700 displays account control panel having a My Account link, a My Login Info link, My Communication Preferences link, a My Profile link, Services Store link in the author control menu 702. The My Account link may enable the user 102 to access his/her user profile only after creating an account (e.g., a user account) and a user name (e.g., Monroe) along with the password to authenticate him/her from other users.

For example, the user 102 (e.g., Monroe) may have access to an account in the publishing environment 100 where he/she can operate a control panel to manage the status and/or stage of his/her project 704 along with the account summary associated with his/her projects. In one embodiment, the account summary indicates the accounting and/or financial records of the orders such as order number, title, qualities and agreed prices, international standard book number, media type, shipping date, tracking number, etc.

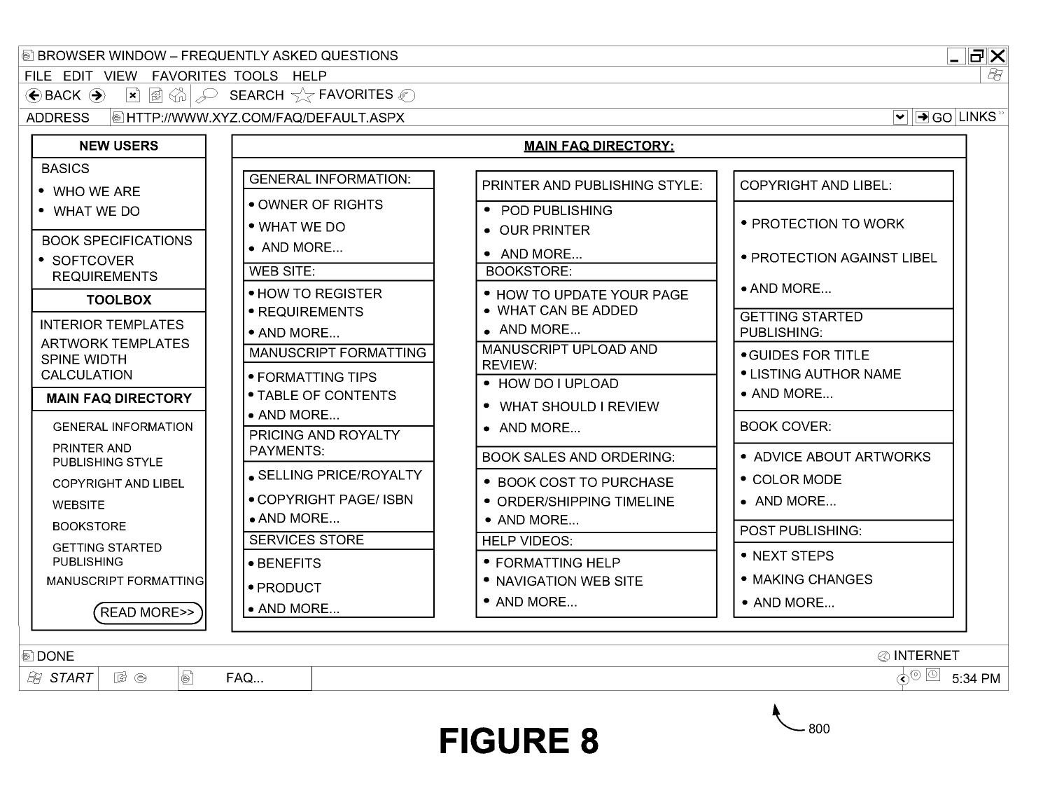

FIG. 8 is a user interface view 800 displaying a help view associated with Frequently Asked Question(s) (FAQ) directory, according to one embodiment. The help view of the user interface view 800 displays the FAQ directory associated with the publishing of the project 104 to the user 102 in a publishing environment 100.

In one embodiment, the help view of the user interface view 800 displays the main FAQ directory menu which provides help options on topics such as General Information, Printing and Publishing style, Copyright and Libel, Word Clay Web Site, Word Clay Bookstore, Getting Started Publishing, Manuscript Formatting, Manuscript Upload/Review, Book Artwork and/or Pricing and Royalty Payments. For example, the user 102 who is utilizing the self publishing services may encounter some problems while publishing his/her project 104 (e.g., a book, a periodical, an audio book, advertising copy, a screenplay, a newsletter, music, a video file, and an audio file) in the publishing environment 100. However, such problems encountered by the user 102 might be solved using the help options available in the main FAQ directory which provides recommendations, supports and suggestions to the user 102.

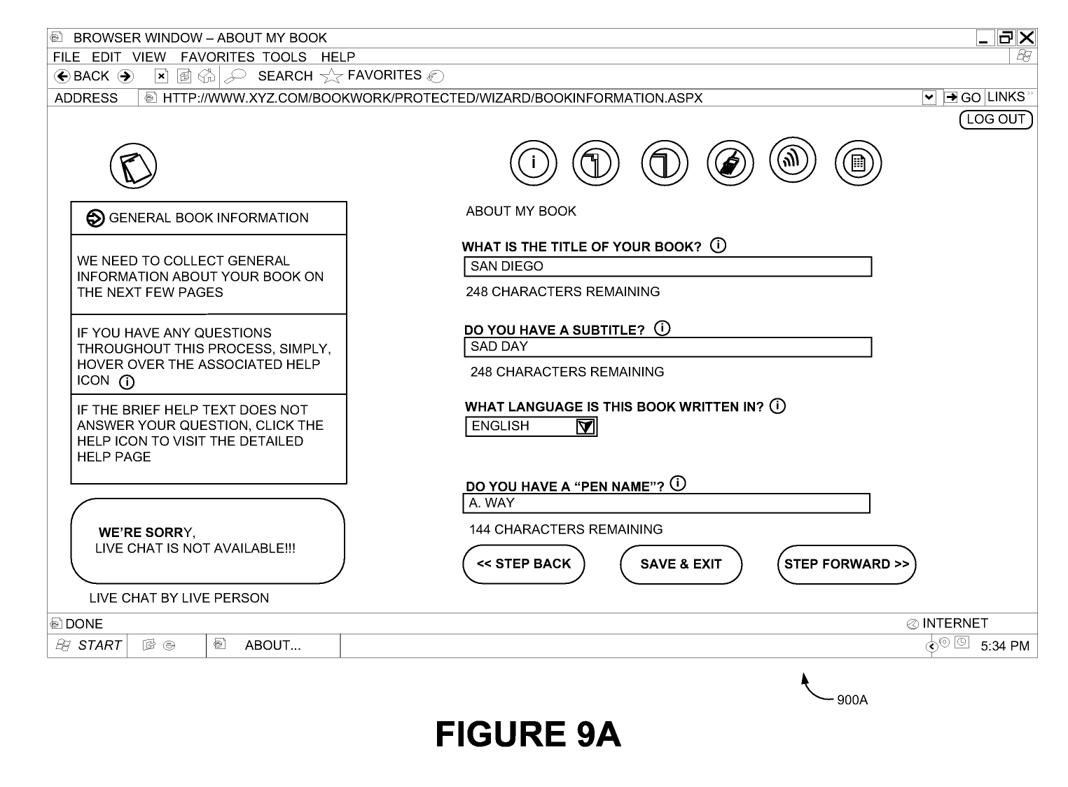

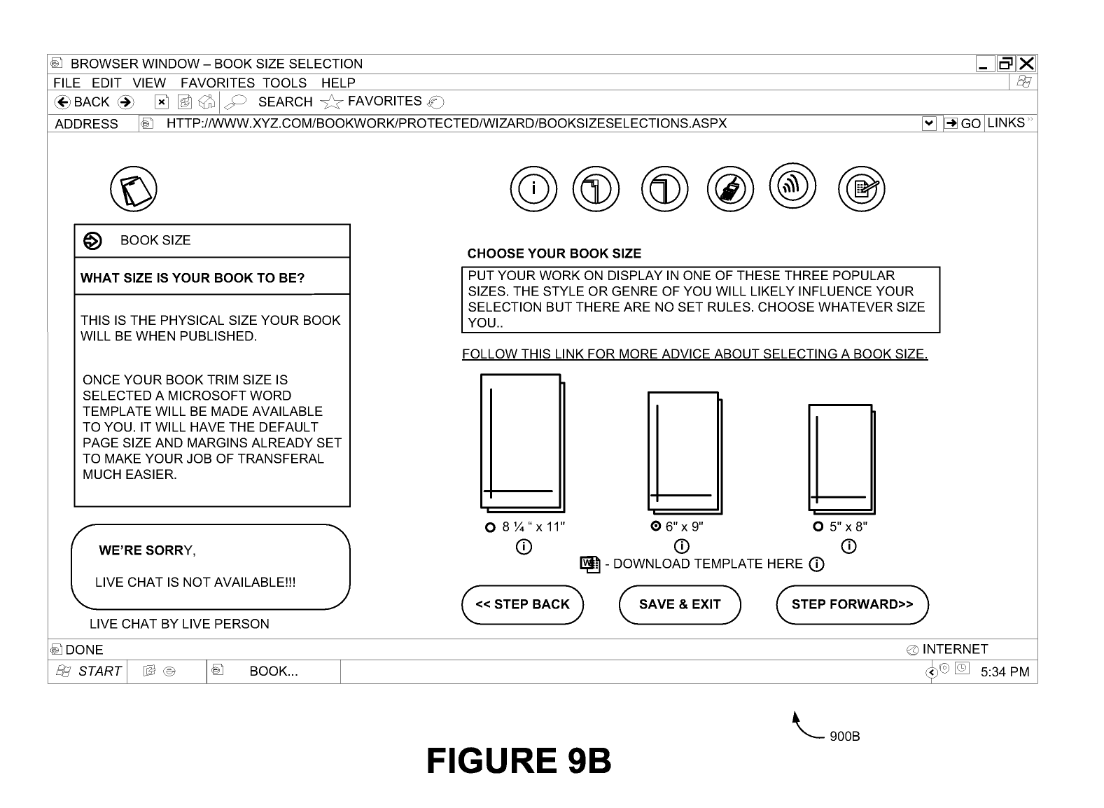

FIG. 9A is a user interface view 900A displaying project information associated with a user profile, according to one embodiment.

The project information view 900A may provide general information about the project 104 (e.g., a book, a periodical, an audio book, advertising copy, a screenplay, a newsletter, music, a video file, and/or an audio file, etc.) associated with the user profile to the user 102 by enabling the publishing environment 100. For example, the user 102 may choose to upload his/her project 104 for publishing in the publishing environment 100 by providing the general information about the project 104. In one embodiment, the general information may include the title of the project 104, subtitle of the project 104, the language in which the project 104 is written and pen name used by the author.

In the example embodiment illustrated in FIG. 9A, the user interface view 900A displays project information associated with the user profile to the user 102. In addition, the user interface view 900A includes the project 104 which may be structured into various fields such as title of the project 104, subtitle of the project 104, the language in which the project 104 is written and pen name used by the author. For example, the user 102 may upload his/her book (e.g., to be published) in the publishing environment 100 by providing general information such as title of the book (e.g., San Diego), subtitle of the book (e.g., Sad Day), the language (e.g., English) in which the book is written and pen name used by the author.

FIG. 9B is a user interface view 900B displaying book sizes associated with the project 104, according to one embodiment.

The user interface view 900B displays a book size (e.g., 8¼×11″, 6″×9″, 5″×8″, etc) that can be selected by the user 102 depending on the industry print standard (e.g., may be a specification and/or requirements given by a publisher, a printer, a distributor, a retailer, a search engine, and/or a registration service). For example, when the user 102 selects the book size in the publishing environment 100 a Microsoft Word template may be automatically created and made available to the user 102 which will have the default page size and default margins already set.

In addition, the default margin may populate the manuscript of the project 104 within the printable margins. Also, the Microsoft Word template may be associated with creation of an automated artwork template for a project 104 which includes generating an image, media type and/or spine sizing.

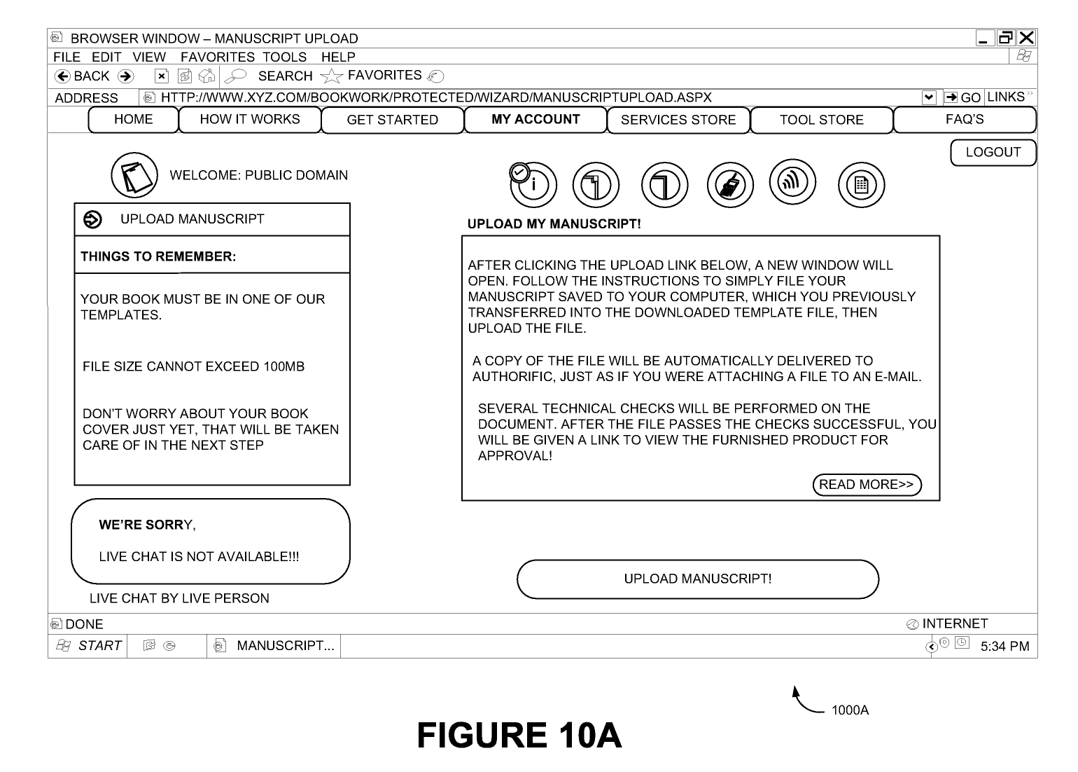

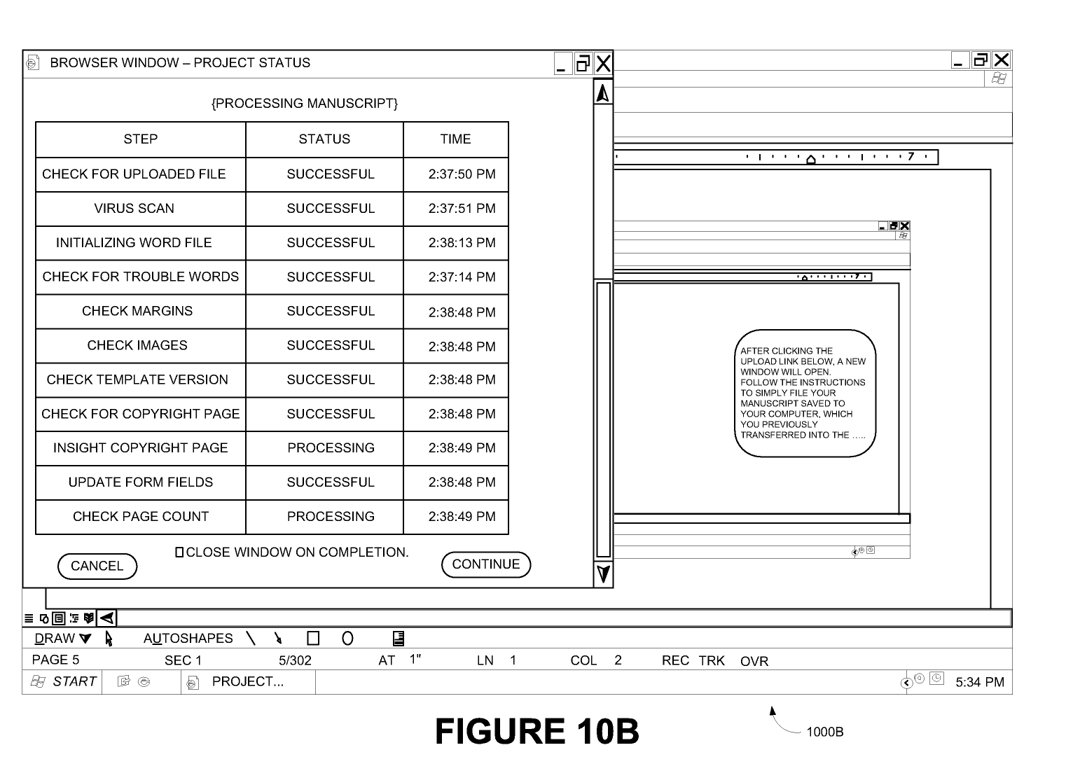

FIG. 10A is a user interface view 1000A for receiving and uploading completed manuscript of the project 104, according to one embodiment.

The user interface view 1000A displays to the public the manuscripts (e.g., which may be unpublished written documents in a form of literary works). The manuscripts may be uploaded by the user 102 using self publishing services in the publishing environment 100. The user interface view may further display a guided instruction steps to the user 102 for uploading the completed manuscripts of the project 104 in the publishing environment 100. For example, the uploaded link may allow the user 102 to follow the instruction steps by saving the manuscript on a computer which was previously transferred into a downloaded template file and then upload the file. The file uploaded by the user 102 may be further passed through several checks before giving a final link to the user 102 to view the finished product that is ready for his/her approval. In one embodiment, the user 102 may select the size (e.g., file size should not exceed 100 MB) of publication of the project 104 and download template of current content of the project 104.

FIG. 10B is a user interface view 1000B of formatting the project 104 in a publishing environment 100, according to one embodiment.

The user interface view 1000B provides the status (e.g., successful, processing, etc.) of the uploaded manuscript to the user 102 in a publishing environment 100. In addition, the user interface view 1000B also displays the steps followed along with the time display in processing the manuscripts. In one embodiment, the steps followed for processing the manuscripts may include checking for uploaded file, scanning for viruses, initializing a word file, checking for trouble words, checking margins, images, template version and a copyright page, inserting a copyright page, updating form fields and checking a page count. The user interface view 1000A further has a click button to close, cancel or continue the processing of the manuscripts that are uploaded by the user 102.

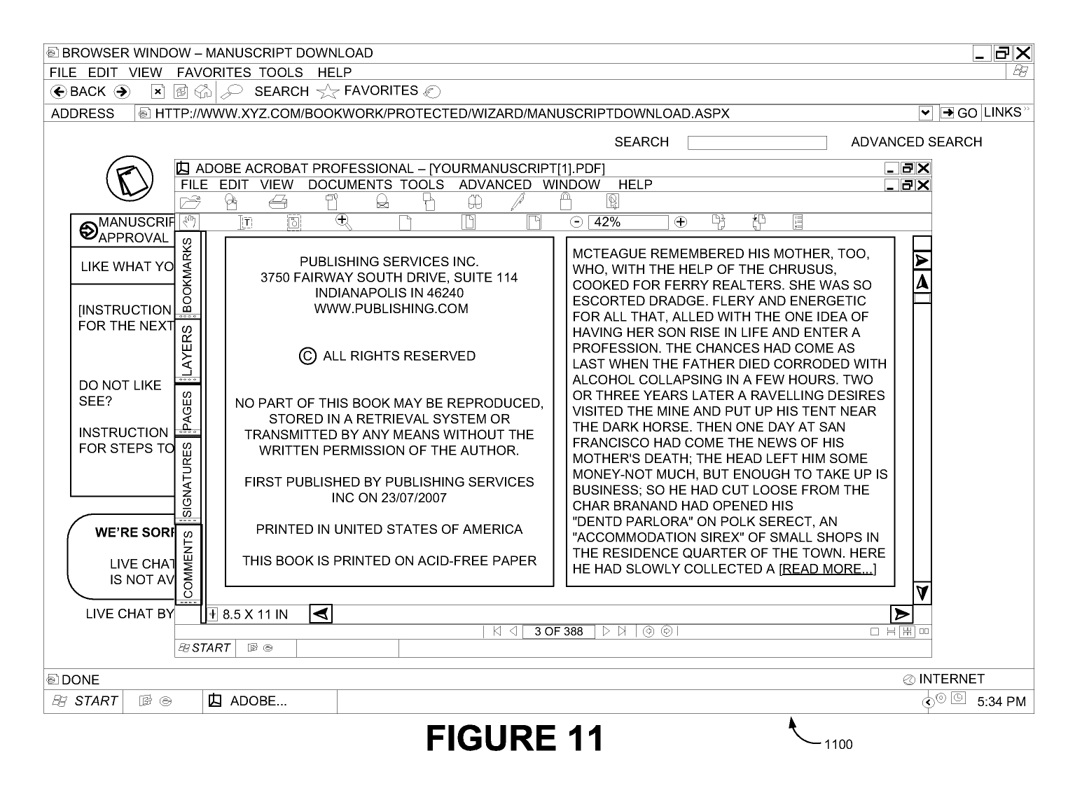

FIG. 11 is a user interface view 1100 displaying the preview of the project 104 to the user 102 in a publishing environment 100, according to one embodiment.

The user interface view 1100 provides the user 102 (e.g., who is uploading the unpublished projects) to opt for a preview feature before publishing his/her project 104 in the publishing environment 100. For example, the preview feature allows the user 102 to see exactly what the pages of the project 104 (e.g., manuscripts) will look like before it is finalized as a finished product for approval. In addition, the user 102 can view and/or fix any page layout problems by using the preview feature. Also, the user 102 can prefer to choose a greater number of pages on a screen depending on the industry standard format. As a result, individual pages may appear smaller on the screen. In one embodiment, the user interface view 1100A also identifies and reports a project related issue by generating recommendations to the user 102 to resolve the project related issue.

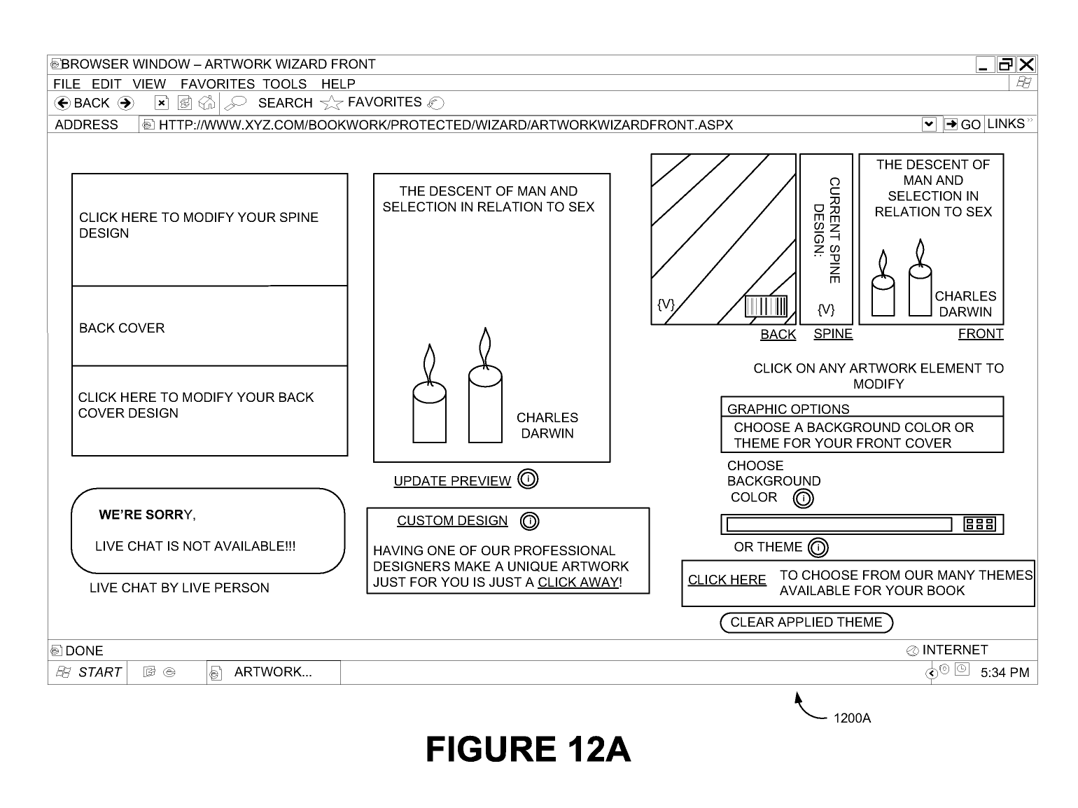

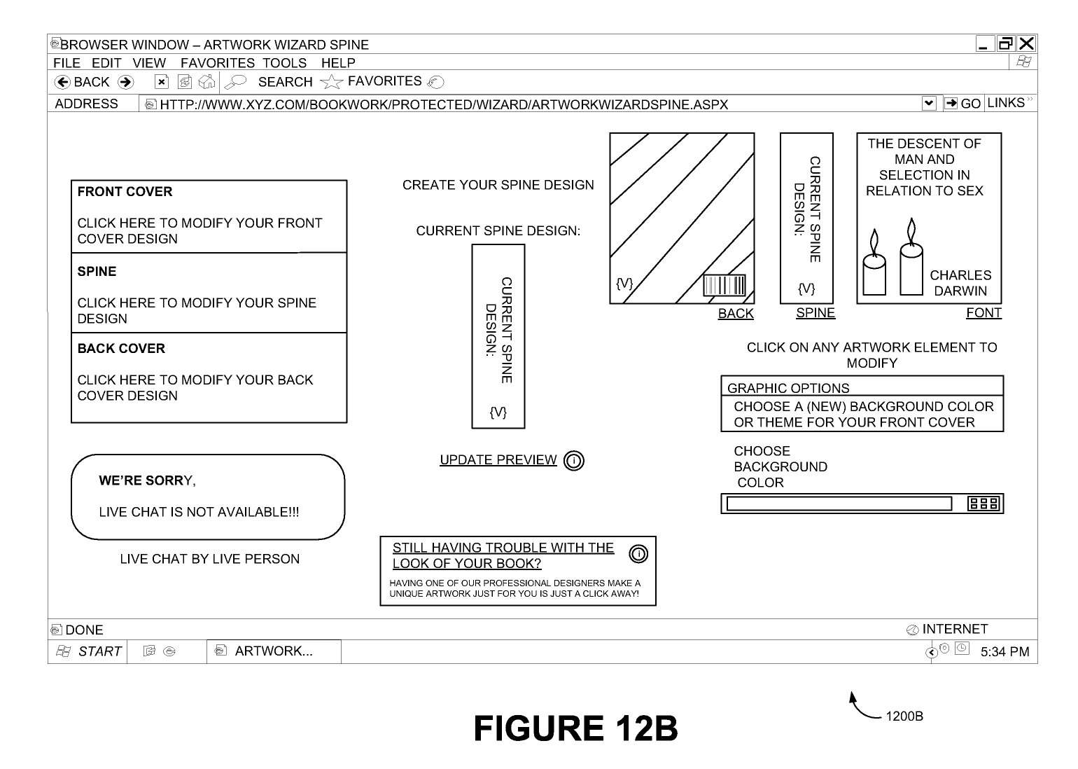

FIG. 12A is a user interface view 1200A enabling the user to create an artwork associated with the project 104 in a publishing environment 100, according to one embodiment.

The user interface view 1200A may enable the user 102 to create, edit, modify, design and/or delete the artwork page according to his/her wish. For example, an artwork template may be used to create the artwork page associated with the project 104. The user interface view 1200A displays graphic options for the user 102 to choose a background color and/or theme for a front cover of the project 104. In addition, the user 102 may choose from the themes that are available through a link displayed in the user interface view 1200A. The user 102 may further opt for a custom design that is provided by a professional designer to make the front artwork page unique. In addition, the user 102 may upload images that are dragged and located to design an artwork layout associated with the artwork of the project 104.

FIG. 12B is a user interface view 1200B enabling the user 102 to create a spine for the artwork associated with the project 104 in a publishing environment 100, according to one embodiment.

The user interface view 1200B may enable the user 102 to create, edit, modify, design and/or delete the spine according to the user's wish. The user interface view 1200B displays graphic options for choosing a background color and/or spine. The user 102 may further opt for a custom design that is provided by professional designer to make the artwork page and the spine unique. In addition, the user 102 may upload images that are dragged and located to design the spine of the artwork layout associated with the artwork of the project 104.

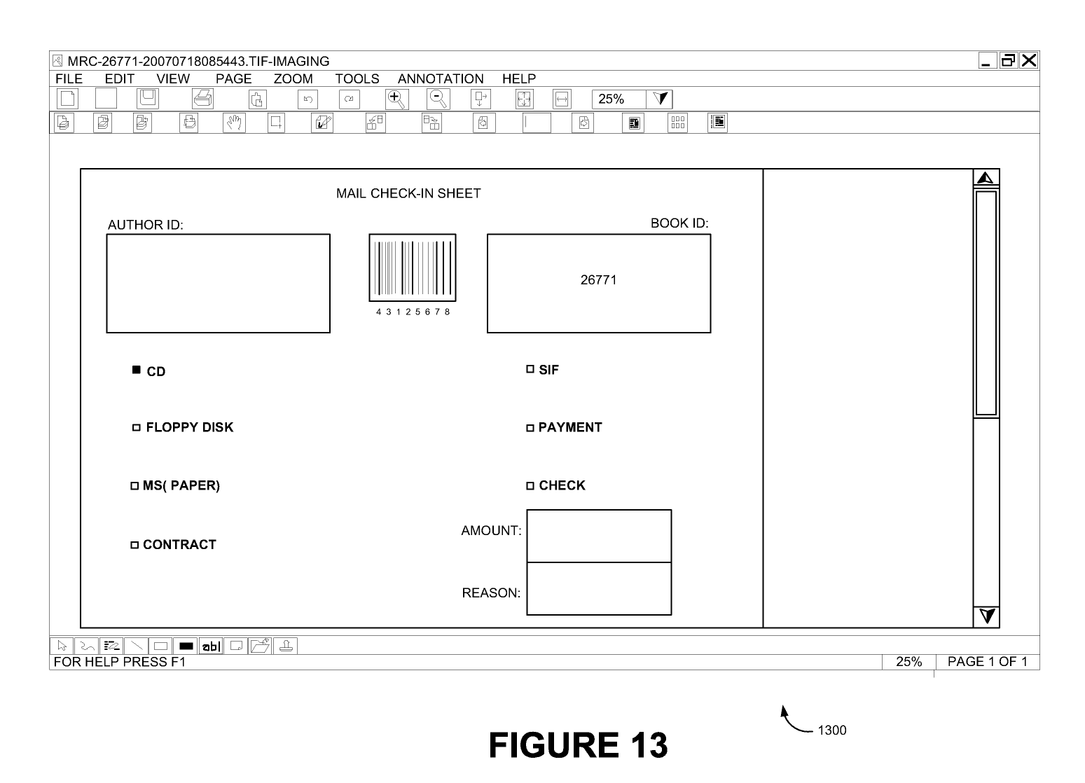

FIG. 13 is a user interface view 1300 illustrating scanning, bar-coding and tracking of projects 104 in the publishing environment 100, according to one embodiment.

In the example embodiment illustrated in FIG. 13, the projects 104 may be integrated into a work flow system. For example, the integration into the work flow system may include integrating the projects 104 into a bar-code reading technology. The projects 104 may be received through different media (e.g., cd, floppy disk, etc). The author ID, book ID, published date, etc. may be bar-coded.

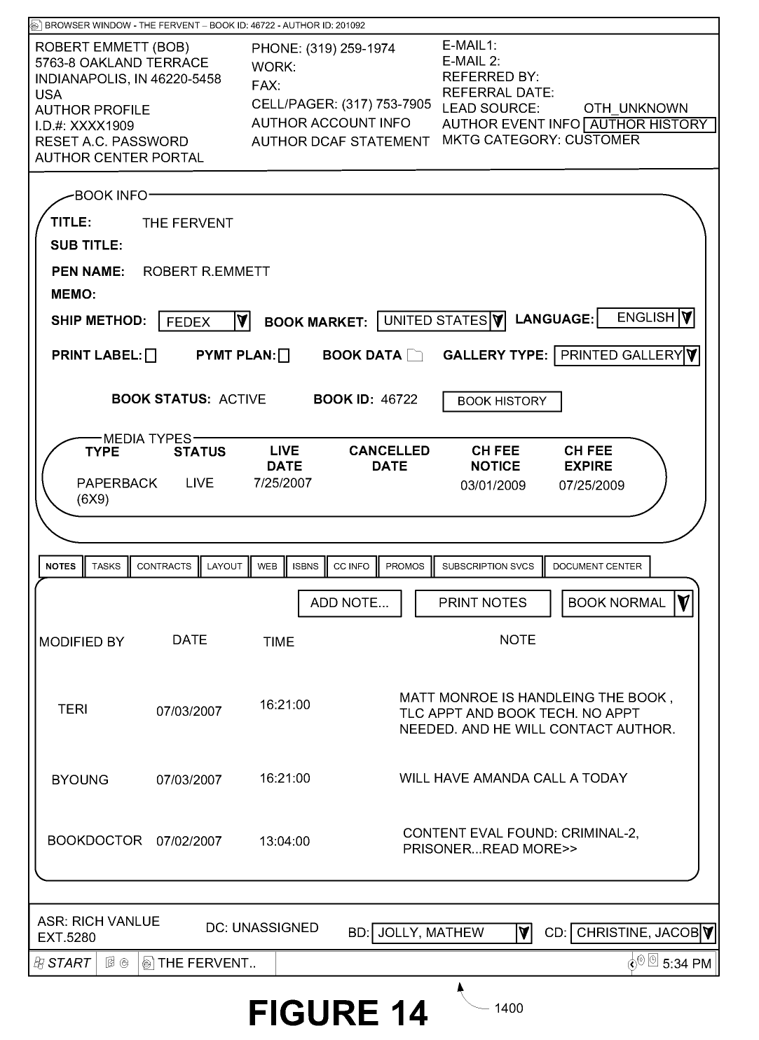

FIG. 14 is a display view 1400 illustrating a libel analysis view associated with the project 104 in the publishing environment 100, according to one embodiment.

In the example embodiment, the libel analysis view of the display view 1400 may have tabs such as Notes, Tasks, Contracts, Layout, Web, ISBNs, CC Info, Promos, Subscription Svcs, Communications and Document Center. In addition, libel analysis view illustrates details of ‘notes’ tab where the notes are modified by the user 102 having a username (e.g., Teri, Byoung, Bookdoctor, etc.). Also, the date and time are specified automatically when the user 102 modifies the notes. In one embodiment the libel analysis view enables the user 102 (e.g., editor/process owner) to check the information associated with the notes of the project 104. Furthermore, the user 102 may choose to select ‘Book Normal’ option, ‘Add Note’ and ‘Print Note’ options that are available for adding and printing notes respectively about the project 104 in the publishing environment 100.

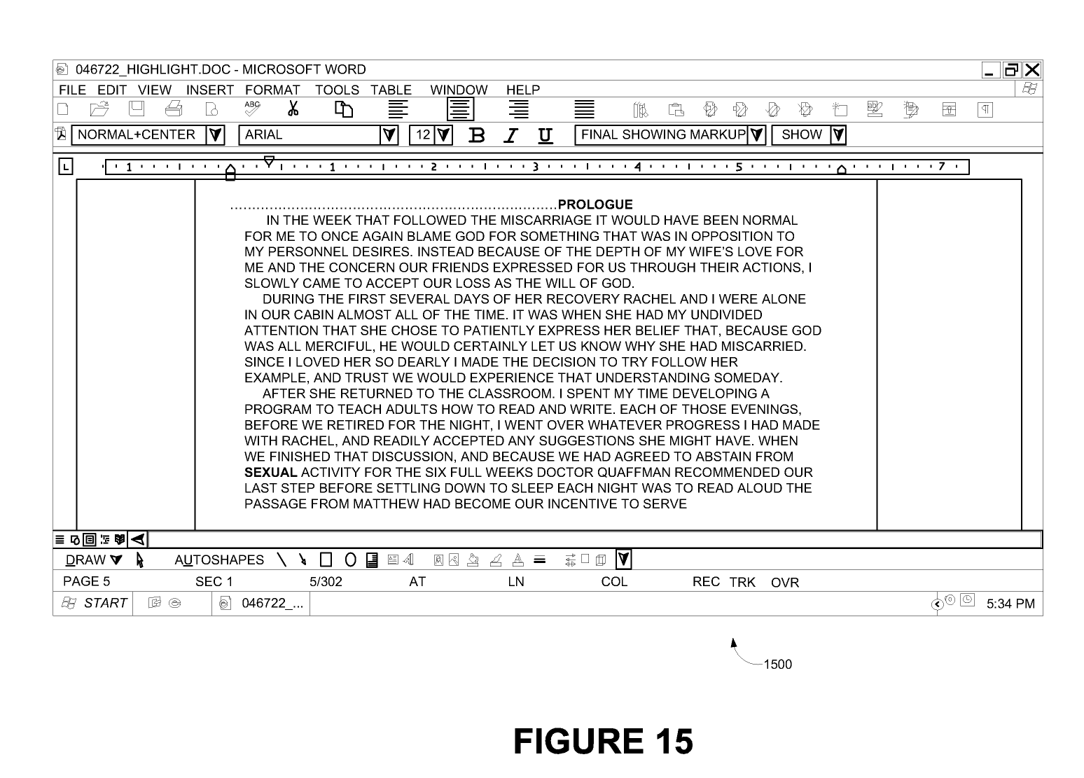

FIG. 15 is a user interface view 1500 displaying a libel analysis associated with a project 104, according to one embodiment. Particularly, FIG. 15 illustrates a text where libelous material is potentially highlighted, according to one embodiment.

In the example embodiment illustrated in FIG. 15, the user interface view 1500 may enable the user 102 (e.g., editor/process owner) to read and analyze the text for any libelous material. For example, words which may be considered as potentially libelous material are highlighted in the text. Further, a summary and a score associated with the libel analysis may be generated and then reviewed.

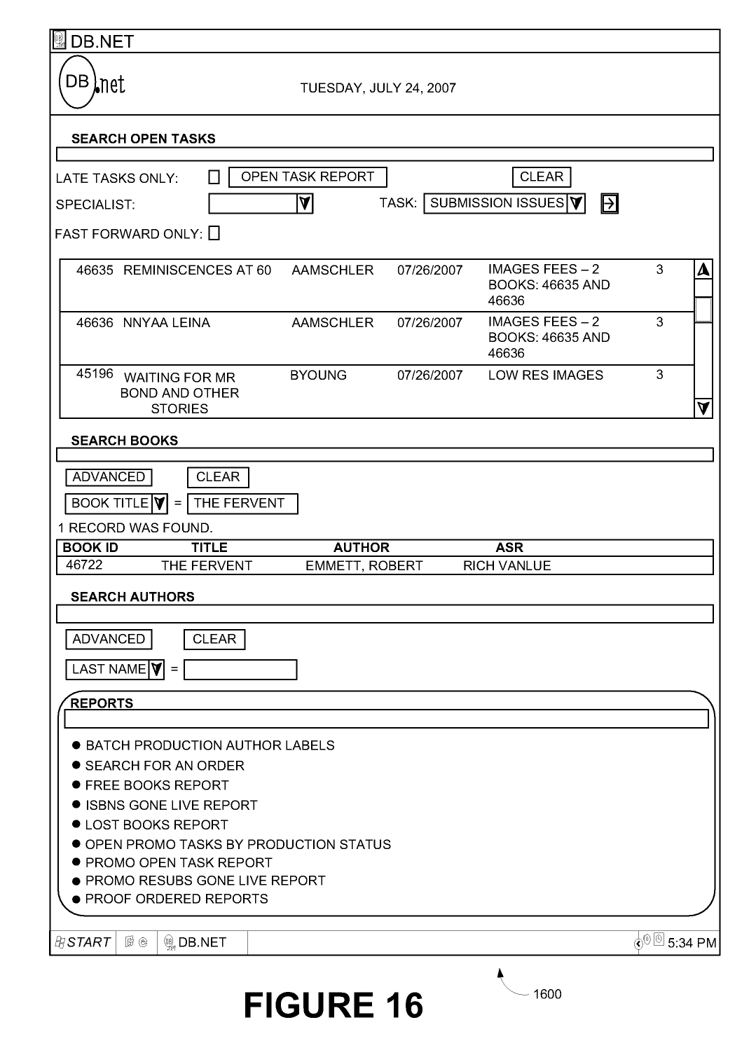

FIG. 16 is a display view 1600 displaying issue identification report along with the resolution view, according to one embodiment.

In the example embodiment illustrated in FIG. 16, the issue identification report/resolution view of the display view 1600 enables the user 102 to search for open tasks, books and/or authors and display the reports associated with the project 104. In one embodiment, searching for open tasks may involve providing information of the specialist (e.g., maybe name of the person who performed the task) and the task assigned (e.g., submission issues, MS and image problems, etc). In another embodiment, searching for books may result in finding the records of the book (e.g., book ID, title, author, etc.) based on the search query (e.g., may involve providing information like the book title) provided by the user 102. In addition, the issue identification report/resolution view displays the reports associated with the issues of the project 104.

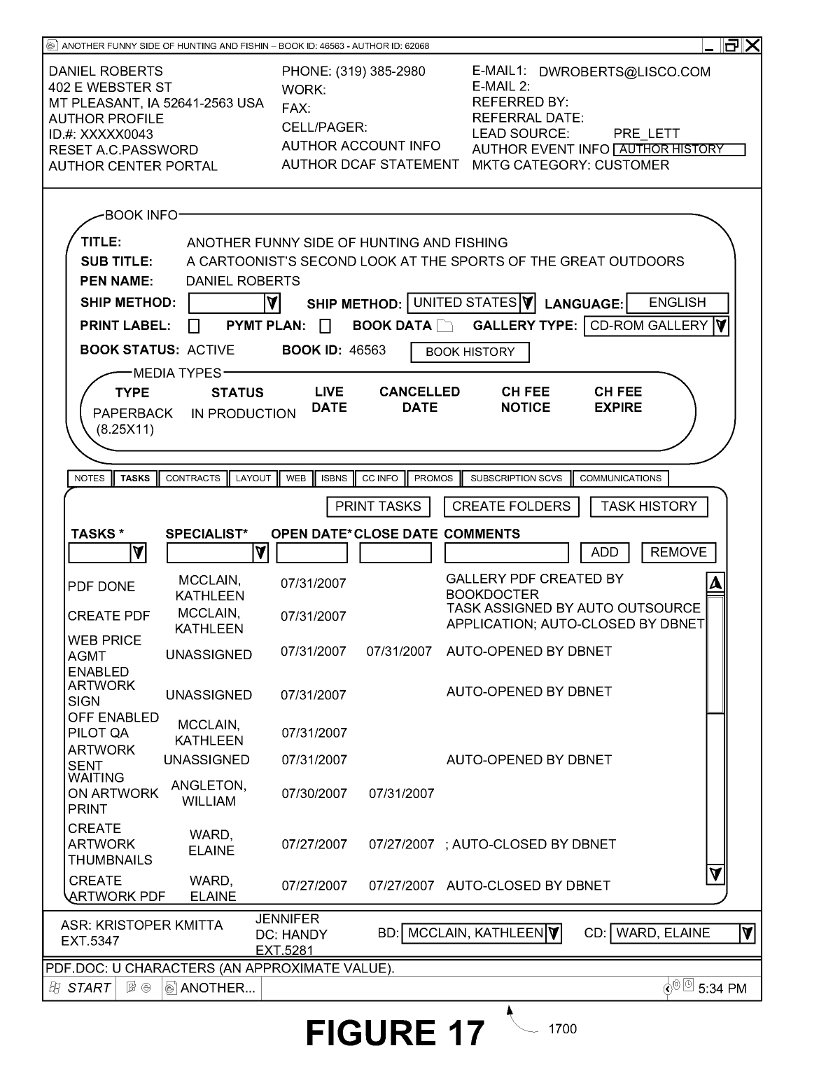

FIG. 17 is a display view 1700 displaying data associated with quality of the document in final quality control view, according to one embodiment. Particularly, FIG. 17 illustrates details of the ‘tasks’ tab of final quality control view, according to one embodiment.

In the example embodiment illustrated in FIG. 17, the display view 1700 enables the user 102 (e.g., publisher) to check the information associated with tasks. The tasks may include task name (e.g. PDF Done, Create PDF, Create Artwork PDF, etc.), specialist (e.g. McClain, Kathleen, Angleton, William, Ward, Elaine, etc.), open date, close date and comments (e.g. gallery PDF created by BookDoctor, auto-opened by DBNet, auto-closed by DBNet, etc.). The open date may be a date on which task is started. The close date may refer to date on which the task is completed. Other options available are ‘Print Tasks’, ‘Create Folders’ and ‘Task History’ associated with a specific task. ‘Add’ and ‘Remove’ tasks are disabled and may be available for authorized users.

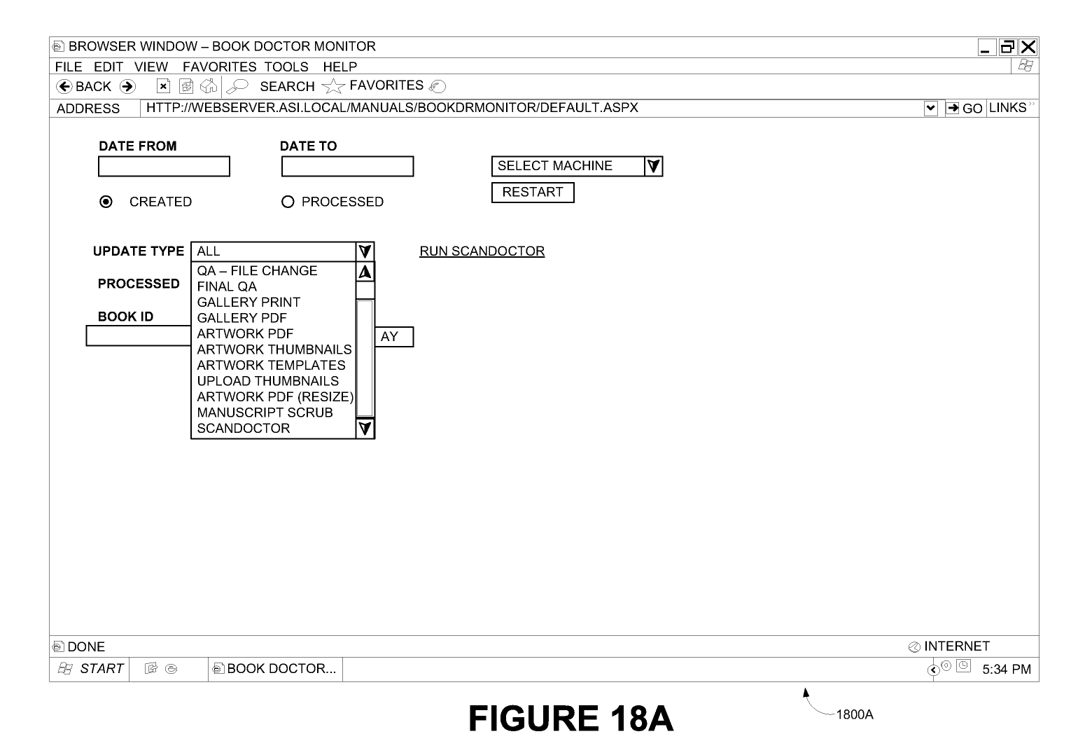

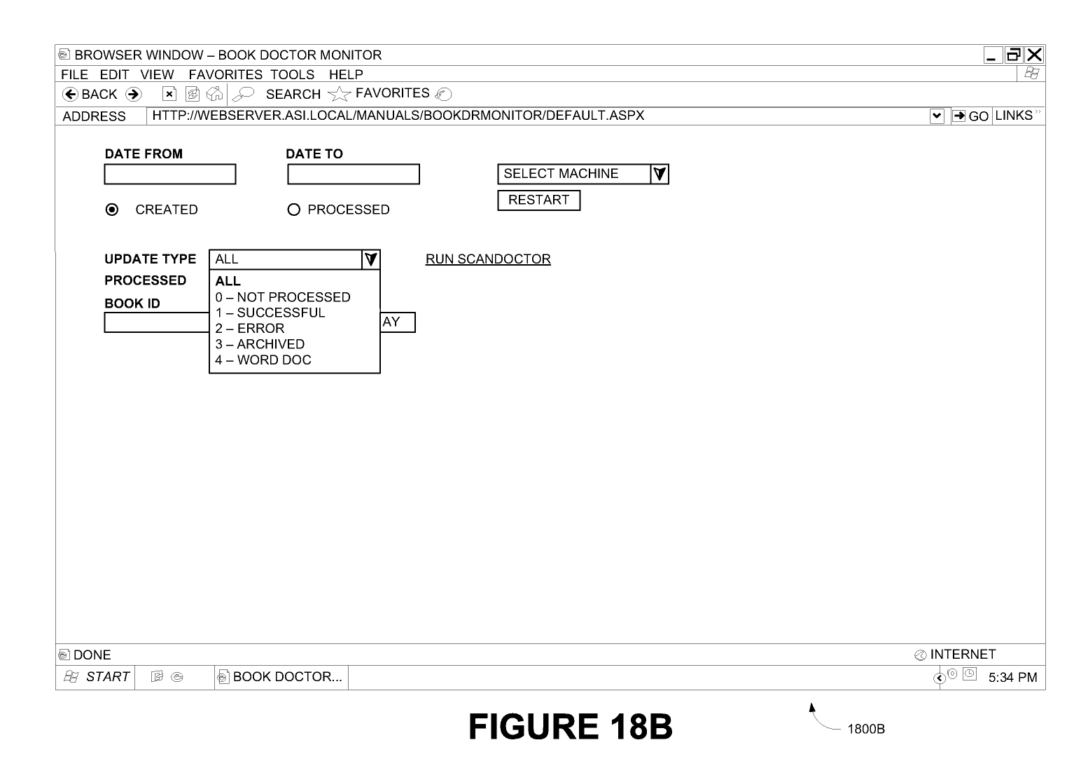

FIG. 18A is a user interface view 1800A of tracking a function associated with the project 104 in the publishing environment 100, according to one embodiment.

The user interface view 1800A displays a track function view associated with the status of the project 104 (e.g., may be a book, a periodical, an audio book, advertising copy, a screenplay, a newsletter, music, a video file, and an audio file.) In one embodiment, the user 102 tracks the functions based on an update type such as QA-File Change, Final QA, Galley Print, Galley PDF, Artwork Thumbnails, Artwork Templates, Upload Thumbnails, Artwork PDF, Manuscript Scrub and/or ScanDoctor. In addition, the user interface view 1800A may also run the ScanDoctor upon selecting the type of update.

FIG. 18B is a user interface view 1800B illustrating processing status associated with the project 104 in the publishing environment 100, according to one embodiment.

The user interface view 1800B displays a process status view associated with the project 104 (e.g., may be a book, a periodical, an audio book, advertising copy, a screenplay, a newsletter, music, a video file, and an audio file). In one embodiment, the user 102 may view the process status associated with the project 104 in a publishing environment 100. The process statuses may be based on process fields such as All, Not Processed, Successful, Error, Archived and/or Word Doc, etc. Each process may be associated with the task of the project 104 and may be identified by assigning a code such as 0—Not Processed, 1—Successful, 2—Error, 3—Archived and/or 4—Word Doc.

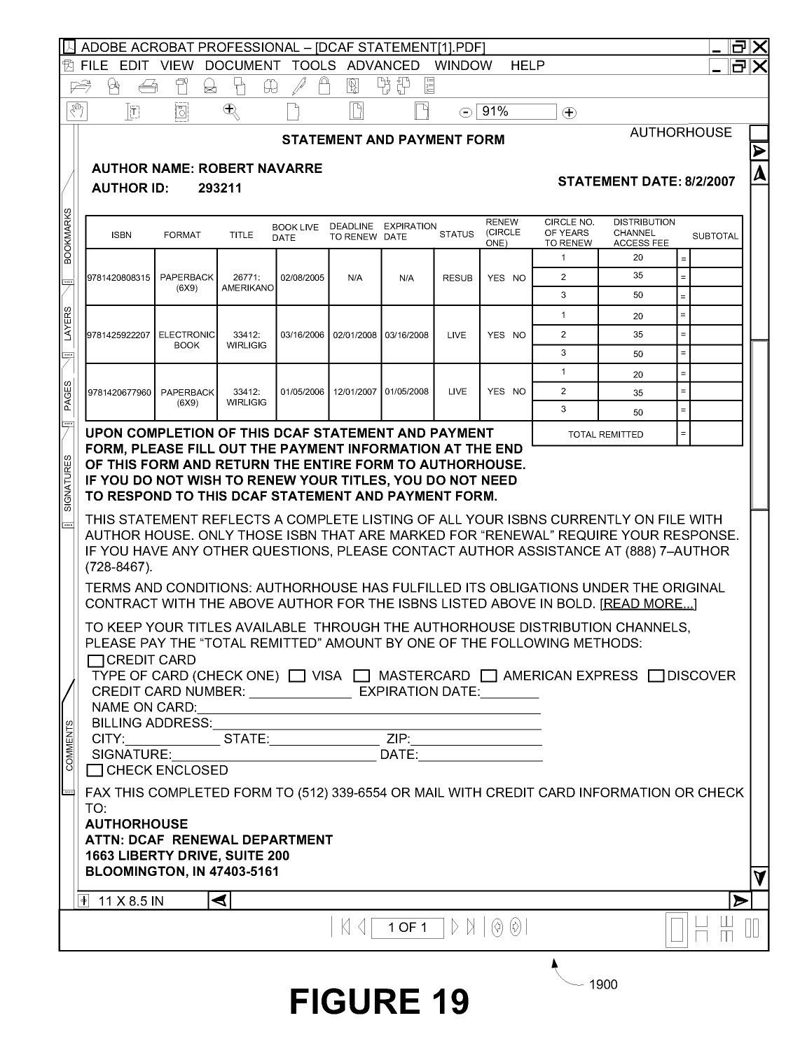

FIG. 19 is a display view 1900 illustrating the post publishing tracking view associated with the project 104 in the publishing environment 100, according to one embodiment.

The post publishing tracking view of the display view 1900 displays information associated to a Distribution Channel Access Fee (DCAF) statement form to the user 102 (e.g., who wish to renew the titles of their project 104) in a table format associated with various fields such as ISBN, Format, Title, Book Live Date, Deadline to Renew, Expiration Date, Status, Renew, No of Years to Renew, Distribution Channel Access Fee and Subtotal of the project 104 corresponding to the author name (e.g., Robert Navarre) and author id (e.g., 293211). In addition, this statement reflects a complete listing of all the ISBNs currently on file for the user 102 along with the response from the user 102 for those ISBNs that are marked for “Renews”. In another embodiment, the post publishing tracking view of the display view 1900 displays a Payment form for the users 102 to fill out the payment information if they wish to renew the titles of their project 104.

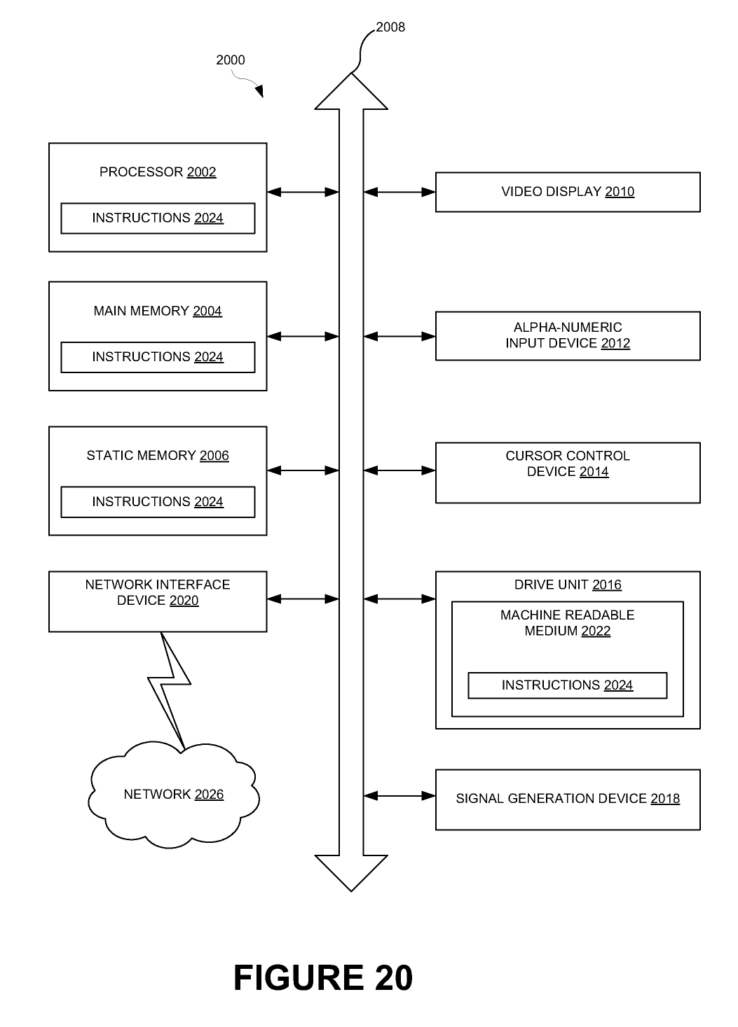

FIG. 20 is a diagrammatic system view 2000 of a data processing system in which any of the embodiments disclosed herein may be performed, according to one embodiment. Particularly, the diagrammatic system view 2000 of FIG. 20 illustrates a processor 2002, a main memory 2004, a static memory 2006, a bus 2008, a video display 2010, an alpha-numeric input device 2012, a cursor control device 2014, a drive unit 2016, a signal generation device 2018, a network interface device 2020, a machine readable medium 2022, instructions 2024 and a network 2026, according to one embodiment.

The diagrammatic system view 2000 may indicate a personal computer and/or a data processing system in which one or more operations disclosed herein are performed. The processor 2002 may be microprocessor, a state machine, an application specific integrated circuit, a field programmable gate array, etc. The main memory 2004 may be a dynamic random access memory and/or a primary memory of a computer system.

The static memory 2006 may be a hard drive, a flash drive, and/or other memory information associated with the data processing system. The bus 2008 may be an interconnection between various circuits and/or structures of the data processing system. The video display 2010 may provide graphical representation of information on the data processing system. The alpha-numeric input device 2012 may be a keypad, keyboard and/or any other input device of text (e.g., a special device to aid the physically challenged). The cursor control device 2014 may be a pointing device such as a mouse.

The drive unit 2016 may be the hard drive, a storage system, and/or other longer term storage subsystem. The signal generation device 2018 may be a bios and/or a functional operating system of the data processing system. The network interface device 2020 may be a device that may perform interface functions such as code conversion, protocol conversion and/or buffering required for communication to and from a network. The machine readable medium 2022 may provide instructions on which any of the methods disclosed herein may be performed. The instructions 2024 may provide source code and/or data code to the processor 2002 to enable any one or more operations disclosed herein.

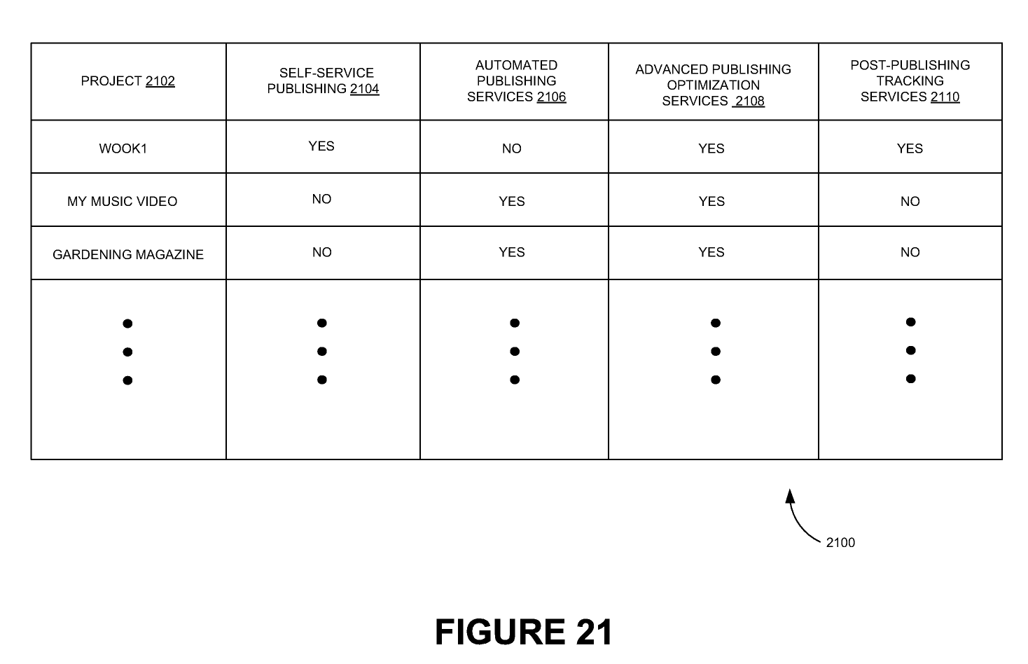

FIG. 21 is a table view 2100 displaying various publishing services associated with the project 104, according to one embodiment. Particularly, FIG. 21 illustrates a project field 2102, a self-service publishing field 2104, an automated publishing services field 2106, an advanced publishing optimization services field 2108, and a post-publishing tracking services field 2110, according to one embodiment.

The project field 2102 may display a type of project 104 that needs to be published. For example, the type of project 104 may be a book, a periodical, an audio book, advertising copy, a screenplay, a newsletter, music, a video file, and/or an audio file. The self-service publishing field 2104 may indicate whether or not the project 104 is published using self-service publishing services in the publishing environment 100. The automated publishing services field 2106 may indicate whether or not the project 104 is published using automated publishing services in the publishing environment 100. The advanced publishing optimization services field 2108 may indicate whether or not the project 104 is published using advanced publishing optimization services in the publishing environment 100. The post-publishing tracking services field 2110 may indicate whether or not the project 104 is published using post-publishing tracking services in the publishing environment 100.

In the example embodiment illustrated in FIG. 21, the project field 2102 displays ‘Wook 1’ in the first row, ‘My Music Video’ in the second row and ‘Gardening Magazine’ in the third row of the project field column 2102. The self-service publishing field 2104 displays ‘Yes’ in the first row, ‘No’ in the second row and ‘No’ in the third row of a self-service publishing field column 2104 (e.g., the project Wook 1 uses self-service publishing services in the publishing environment 100 while projects My Music Video and Gardening Magazine do not use self-service publishing services). The automated publishing services field 2106 displays ‘No’ in the first row, ‘Yes’ in the second row and ‘Yes’ in the third row of automated publishing services field column 2106 (e.g., the projects My Music Video and Gardening Magazine use automated publishing services in the publishing environment 100 while the project Wook 1 does not involve automated publishing services). The advanced publishing optimization services field 2108 displays ‘Yes’ in the first row, ‘Yes’ in the second row and ‘Yes’ in the third row of advanced publishing optimization services field column 2108 (e.g., the projects Wook 1, My Music Video and Gardening Magazine use advanced publishing optimization services in the publishing environment 100). The post-publishing tracking services field 2110 displays ‘Yes’ in the first row, ‘No’ in the second row and ‘No’ in the third row of post-publishing tracking services field column 2110 (e.g., the project Wook 1 uses post-publishing tracking services in the publishing environment 100 while the projects My Music Video and Gardening Magazine do not use post-publishing tracking services).

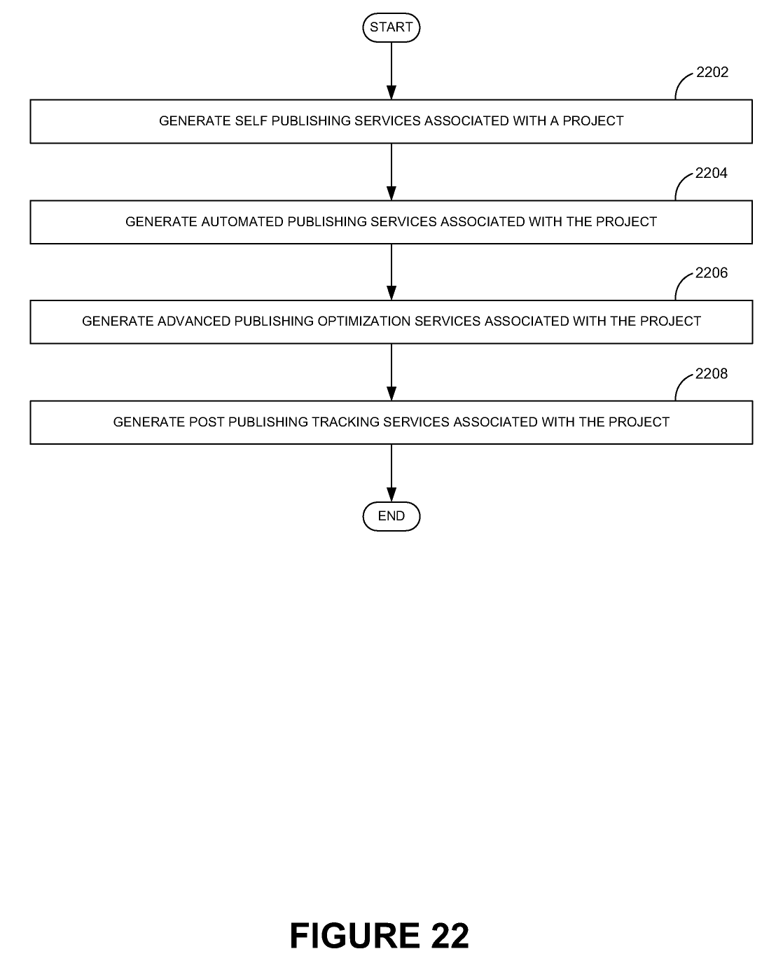

FIG. 22 is a process flow of generating publishing services associated with a project 104, according to one embodiment. In operation 2202, self publishing services associated with a project (e.g., of the unpublished projects 104 of FIG. 1) may be generated (e.g., using the self publishing module 108 of FIG. 1). In operation 2204, automated publishing services associated with the project 104 may be generated (e.g., using the automated publishing module 110 of FIG. 1). In operation 2206, advanced publishing optimization services associated with the project 104 may be generated (e.g., using the advanced publishing optimization module 112 of FIG. 1). In operation 2208, generating post publishing tracking services associated with the project 104 may be generated (e.g., using the post publishing tracking module 114 of FIG. 1).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the self publishing module 108, the automated publishing module 110, the advanced publishing optimization module 112, the post publishing tracking module 114, the publication module 202, the create artwork module 204, the offer module 206, the pricing module 208, the distribution module 210, the artwork services module 212, the upgraded services module 214, the scan module 302, the format conversion module 304, the libel analysis module 306, the presentation module 308, the automated print module 310, the convert source format module 312, the libel report module 314, the font module 316, the analysis module 318, the margin module 320, the attachment module 322, the page module 324, the artwork template creation module 326, the specialized printing module 328, the population module 330, the integration module 402, the workflow state system module 404, the load balance module 406, the submission module 408, the artwork spine module 410, the automatic review module 412, the extraction module 414, the validation module 416, the issue module 418, the resolution module 420, the system integration module 422, the post publishing price module 502, the marketing preferences module 504, the author page module 506, the order module 508, the royalties module 510, the sales module 512, the tracking module 514, the alert module 516, the website module 518, the communication module 520, and other modules of FIGS. 1-22 may be enabled using a self publishing circuit, a automated publishing circuit, a advanced publishing optimization circuit, a post publishing tracking circuit, a publication circuit, a create artwork circuit, a offer circuit, a pricing circuit, a distribution circuit, an artwork services circuit, a upgraded services circuit, a scan circuit, a format conversion circuit, a libel analysis circuit, a presentation circuit, a automated print circuit, a convert source format circuit, a libel report circuit, a font circuit, an analysis circuit, a margin circuit, an attachment circuit, a page circuit, an artwork template creation circuit, a specialized printing circuit, a population circuit, a integration circuit, a workflow state system circuit, a load balance circuit, a submission circuit, an artwork spine circuit, a automatic review circuit, a extraction circuit, a validation circuit, a issue circuit, a resolution circuit, a system integration circuit, a post publishing price circuit, a marketing preferences circuit, a author page circuit, a order circuit, a royalties circuit, a sales circuit, a tracking circuit, a alert circuit, a website circuit, a communication circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
generating self publishing services associated with a project;
generating automated publishing services associated with the project;
generating advanced publishing optimization services associated with the project; and
generating post publishing tracking services associated with the project.

2. The method of claim 1, wherein the generating self publishing services associated with a project comprises at least one of:
selecting a media type and a size of publication of the project;
downloading templates of current content of the project;
receiving uploaded completed manuscripts of the project;
creating an artwork associated with the project;
generating targeted offers of upgraded services;
setting at least one of a pricing of the project and a retail discount amount of the project; and
selecting optional distribution services of the project.

3. The method of claim 2, wherein the creating an artwork associated with the project comprises at least one of:
receiving an uploaded existing artwork based on a provided template;
generating the artwork via an artwork wizard having guided instruction steps;
selecting a theme category of the artwork;
selecting a background color of the artwork;
selecting at least one of a font style, a font size, and a font color of at least one of a title of the project, a subtitle of the project, and a pen name of the project;
generating at least one of front cover of the artwork, back cover of the artwork, and a spine of the artwork;
receiving uploaded images associated with the artwork; and
dragging and locating artwork elements to design an artwork layout.

4. The method of claim 1, wherein the generating automated publishing services associated with the project comprises at least one of:
generating a virus scan of the project;
automatically converting the project from a first format to a second format;
generating a libel analysis of the project;
generating a presentation of the project; and
generating automated print services.

5. The method of claim 4, wherein the generating a libel analysis of the project comprises at least one of:
highlighting a portion of the project potentially associated with libel;
generating a summary of the libel analysis of the project; and
generating a score associated with the libel analysis of the project.

6. The method of claim 4, wherein the generating a presentation of the project comprises at least one of:
generating a font analysis of the project;
generating an analysis associated with at least one of an image resolution and an image size of the project;
generating automated margins of the project;
automatically attaching at least one of an image file and a non-image file to the project;
generating at least one of an automated page numbering verification of the project and an automated calculation of the pages of the project; and
generating an automated artwork template creation associated with the project.

7. The method of claim 1, wherein the generating advanced publishing optimization services associated with the project comprises at least one of:
integrating the project into at least a portion of a workflow system;
generating a workflow state system of the workflow system;
load balancing the project within the workflow system and prioritizing work logic;
automatically submitting, in industry standard format, at least one of the project and metadata associated with the project;
automatically maintaining an artwork spine size associated with galley changes to the project;
automatically reviewing material associated with at least one of the issues of the project and revenue opportunities associated with the project;
extracting metadata associated with the project;
validating data of the project and content consistency of the project between at least one of an artwork, a galley, accounting records, financial records, and a work flow system; identifying and reporting a project related issue; and
generating at least one recommendation to resolve the project related issue.

8. The method of claim 7, wherein the generating a workflow state system of the workflow system comprises driving at least one of proper events, sequences, decisions, and parallel activities to at least one destination, comprising automated comments and automated notes.

9. The method of claim 7, wherein the automatically submitting, in industry standard format, at least one of the project and metadata associated with the project comprises automatically submitting, in industry standard format, at least one of the project and metadata associated with the project to at least one of a publisher, a printer, a distributor, a retailer, a search engine, and a registration service.

10. The method of claim 1, wherein the generating post publishing tracking services associated with the project comprises at least one of:
generating a price related to the project;
determining marketing preferences associated with the project;
generating customized author pages associated with the project;
generating orders associated with the project;
managing royalties associated with the project;
managing sales activities associated with the project;
tracking a status associated with the project;
generating at least one of an alert and a notification associated with the project;
generating at least one website to promote the project; and
generating a communication associated with the project.

11. The method of claim 1, wherein the project is associated with at least one of a book, a periodical, an audio book, advertising copy, a screenplay, a newsletter, music, a video file, and an audio file.

12. The method of claim 1 in a form of a machine-readable medium embodying a set of instructions that, when executed by a machine, causes the machine to perform the method of claim 1.

13. A system, comprising
a self publishing module to generate self publishing services associated with a project;
an automated publishing module to generate automated publishing services associated with the project;
an advanced publishing optimization module to generate advanced publishing optimization services associated with the project; and
a post publishing tracking module to generate post publishing tracking services associated with the project.

14. The system of claim 13, wherein the self publishing module comprises at least one of:
a publication module to select a media type and a size of publication of the project, to download templates of current content of the project, and to receive uploaded completed manuscripts of the project;
a create artwork module to create an artwork associated with the project;
an offer module to generate targeted offers of upgraded services;
a pricing module to set at least one of a pricing of the project and a retail discount amount of the project; and
a distribution module to select optional distribution services of the project.

15. The system of claim 14, wherein the create artwork module comprises an artwork services module to perform at least one of the following:
receive an uploaded existing artwork based on a provided template;
generate an artwork via an artwork wizard having guided instruction steps;
select a theme category of the artwork;
select a background color of the artwork;
select at least one of a font style, a font size, and a font color of at least one of a title of the project, a subtitle of the project, and a pen name of the project;
generate at least one of a front cover of the artwork, a back cover of the artwork, and a spine of the artwork;
receive uploaded images associated with the artwork; and
permit dragging and locating artwork elements to design an artwork layout.

16. The system of claim 13, wherein the automated publishing module comprises at least one of:
a scan module to generate a virus scan of the project;
a format conversion module to automatically convert the project from a first format to a second format;
a libel analysis module to generate a libel analysis of the project;
a presentation module to generate a presentation of the project; and
an automated print module to generate automated print services.

17. The system of claim 16, wherein the libel analysis module comprises a libel report module to perform at least one of the following:
highlight a portion of the project potentially associated with libel;
generate a summary of the libel analysis of the project; and
generate a score associated with the libel analysis of the project.

18. The system of claim 16, wherein the presentation module further comprises at least one of:
a font module to generate a font analysis of the project;
an analysis module to generate an analysis associated with at least one of an image resolution and an image size of the project;
a margin module to generate automated margins of the project;
an attachment module to automatically attach at least one of an image file and a non-image file to the project;
a page module to generate at least one of an automated page numbering verification of the project and an automated calculation of the pages of the project; and
an artwork template creation module to generate an automated artwork template creation associated with the project.

19. The system of claim 13, wherein the advanced publishing optimization module associated with the project comprises at least one of:
an integration module to integrate the project into at least a portion of a workflow system;
a workflow state system module to generate a workflow state system of the workflow system;
a load balance module to load balance the project within the workflow system and to prioritize work logic;
a submission module to automatically submit, in industry standard format, at least one of the project and metadata associated with the project;
an artwork spine module to automatically maintain an artwork spine size associated with galley changes to the project;
an automatic review module to automatically review material associated with at least one of issues of the project and revenue opportunities associated with the project;
an extraction module to extract metadata associated with the project;
a validation module to validate data of the project and content consistency of the project between at least one of an artwork, a galley, accounting records, financial records, and a work flow system;
an issue module to identify a project related issue and report the project related issue;
and a resolution module to generate at least one recommendation to resolve the project related issue.

20. The system of claim 19, wherein the workflow state system module further operates to drive at least one of proper events, sequences, decisions, and parallel activities to at least one destination comprising automated comments and automated notes.

21. The system of claim 19, wherein the submission module submits, in industry standard format, at least one of the project and metadata associated with the project to at least one of a publisher, a printer, a distributor, a retailer, a search engine, and a registration service.

22. The system of claim 13, wherein the post publishing tracking module associated with the project comprises at least one of:
a post publishing price module to generate a price related to the project;
a marketing preferences module to determine marketing preferences associated with the project;
an author page module to generate customized author pages associated with the project;
an order module to generate orders associated with the project;
a royalties module to manage royalties associated with the project;
a sales module to manage sales activities associated with the project;
a tracking module to track a status associated with the project;
an alert module to generate at least one of an alert and a notification associated with the project;
a website module to generate at least one website to promote the project; and
a communication module to generate a communication associated with the project.

23. The system of claim 13, wherein the project comprises at least one of a book, a periodical, an audio book, advertising copy, a screenplay, a newsletter, music, a video file, and an audio file.

24. A publishing environment, comprising:
a first instruction set to enable the publishing environment, to include a project database having projects, and to generate a virus scan of at least one project of the projects;
a second instruction set integrated with the first instruction set to automatically convert the project from a first format to a second format;
a third instruction set integrated with the first instruction set and the second instruction set to generate a libel analysis of the project;
a fourth instruction set integrated with the first instruction set, the second instruction set, and the third instruction set to generate a presentation of the project; and
a fifth instruction set integrated with the first instruction set, the second instruction set, the third instruction set, and the fourth instruction set to generate automated print services associated with the project.

25. The publishing environment of claim 24, further comprising:
a sixth instruction set to automatically convert the first format of a source document of the project to the second format associated with at least one of a typesetting application and a business requirement, to highlight a portion of the project potentially associated with a libel, to generate a summary of the libel analysis of the project, and to generate a score associated with the libel analysis of the project.
